(19) United States
(12) Patent Application Publication
(10) Pub. No.: US 2024/0217787 A1
(43) Pub. Date: Jul. 4, 2024

(54) MODULAR WINCH ARCHITECTURE AND CONTROL SYSTEM

(71) Applicant: Polaris Industries Inc., Medina, MN (US)

(72) Inventors: Paul Leonard Mattson, Harris, MN (US); Jeremiah Johnstun, Elk River, MN (US); Lucas Frank Budzien, Osceola, WI (US); Aidan Shaughnessy, Overland Park, KS (US); George Liu, White Bear Lake, MN (US); Joshua James DeSmet, North Branch, MN (US); Tim Norstad, Turtle Lake, WI (US)

(21) Appl. No.: 18/399,998

(22) Filed: Dec. 29, 2023

Related U.S. Application Data
(60) Provisional application No. 63/435,821, filed on Dec. 29, 2022.

(51) Int. Cl. B66D 1/28; B66D 1/12; B66D 1/22; B66D 1/36

(52) U.S. Cl. CPC B66D 1/28; B66D 1/12; B66D 1/22; B66D 1/36; B66D 2700/0183

(57) ABSTRACT

Modular winch system and associated devices are disclosed. In one or more embodiments the modular winch system includes a spool and a spool frame including a first frame portion and a second frame portion configured to rotatably support the spool. In one or more embodiments the system includes a plurality of winch modules including a motor, a gearbox, and a fairlead each connected to the spool frame, where the motor and gearbox are attached to frame portions, and each have a plurality of potential rotational orientations defined a plurality of universal attachment holes. In various embodiments, the spool frame is attachable to the vehicle in at least two orientations including a horizontal orientation where the plurality of mounting holes are approximately horizontal relative to the earth, and a vertical mounting orientation where the plurality of mounting holes are approximately vertical relative to the earth.

### CROSS REFERENCE TO RELATED APPLICATION

This patent application claims the benefit of U.S. Provisional Application No. 63/435,821, titled MODULAR WINCH ARCHITECTURE AND CONTROL SYSTEM, filed Dec. 29, 2022, the entire contents of which are expressly incorporated by reference herein.

### BACKGROUND

A vehicle winch is a device that is used to pull or lift heavy objects using a motor and a spool with a rope or cable. Vehicle winches are commonly found on trucks and other off-road vehicles, and they can be used for a variety of purposes, including towing, rescue operations, and loading heavy equipment. Winches are often used to recover a stuck vehicle or object. For example, if a vehicle gets stuck in mud, sand, snow, or another difficult terrain, a winch can be used to pull the vehicle free. The winch cable is attached to the stuck vehicle and then to a sturdy anchor point, such as a tree or another vehicle. The winch motor is then activated, pulling the stuck vehicle free.

Winches are also used to tow another vehicle. For example, if a vehicle breaks down or gets stuck, a winch can be used to attach the disabled vehicle to another vehicle and then tow it to safety. This can be especially useful in remote areas where there is no access to a tow truck. Finally, vehicle winches can also be used for loading and unloading heavy equipment. A winch can be used to lift and move heavy objects, such as logs or construction materials, making it easier to load and unload them from a vehicle. Overall, vehicle winches are versatile tools that can be used for a variety of purposes, making them an essential part of any off-road vehicle toolkit.

### SUMMARY

One or more embodiments of the disclosure are directed to a modular and/or rotatable winch architecture. In some examples, winch design may be based on a semi-standardized architecture that allows some components to be swapped or interchanged during manufacture. For example, the Polaris® 4500 and 6000 HD winches utilize several standardized parts to reduce the total number of parts and increase flexibility in product planning and manufacture. As such, various embodiments of the disclosure are directed to a winch architecture that is designed to further standardize winch components to further reduce complexity, further reduce the total number of components, and further improve flexibility and ease in manufacturing. For example, various embodiments of the disclosure allow for previously non-standardized components, such as the winch gearbox, to be attached to a standardized platform.

In addition, various embodiments provide a standardized design that allows for multiple rotational orientations of attached components for easier connection to a variety of different recreational vehicles. For example, various embodiments allow for both horizontal and vertical mounting to a vehicle bumper without requiring the use of alternate components. In such embodiments, these orientations improve the flexibility to both manufacturers and users to allow for multiple component placement options and increase winch compatibility with many different vehicle designs.

Further, various embodiments allow for individual winch components, such as the motor and gearbox, to be attached to the winch in a variety of rotational orientations. In such embodiments, the individual components can be rotated to accommodate the space available in either horizontal or a vertical mounting orientation. For example, in certain embodiments, the gearbox and motor can be rotated to a position when mounted that allows for operator access to important components such as power terminals, freespool handles, and the like. Finally, by platforming in this manner, many versions of the winch can be offered to customers, as well as allowing customers to upgrade their winch and customize it by replacing portions of the winch without requiring the wholesale replacement to upgrade features.

For example, various embodiments of the disclosure contemplate a modular winch architecture that can universally accommodate different core winch components such as the motor, gearbox, spool, main frame, and fairlead. For example, one or more embodiments allow for universal connection to both standard DC or brushless DC motors, different spool lengths, different gearbox speeds such as single speed or multi-speed gearboxes, different fairleads including auto-stop functional fairleads or even no fairlead. Further, various embodiments enable the use of the use of brushless DC winch motors and controls which would enable a “connected” or “smart” winch technology, which would communicate with the vehicle controls and enable synergistic functionality of the vehicle and winch systems. This platform would also enable direct manual, remote manual, and wireless remote operation of shift and freespool commands on the winch, of which only direct manual is currently commercially available.

In various embodiments the modular winch architecture is supported by a novel spool frame design. In such embodiments the spool frame defines a first and second frame supports each having a plurality of universal mounting locations and interfaces for the various part groupings. In some embodiments the first and second spool supports are interchangeable such that the total number of individual components are reduced while also allowing for modular component placement while also providing component stability throughout the use of the platform. As such, in various embodiments, based on known or anticipated configurations of the components in this system, at least 48 base configurations of winches could be made, not accounting for differences in fairlead style, rope type, presence of Auto-stop, presence of wireless winch control, or other options.

In one or more embodiments a modular winch comprises, a spool and a spool frame including a first frame portion and a second frame portion configured to rotatably support the spool therebetween. In one or more embodiments the spool frame includes a top plate connecting the first and second frame portions and defining a top side of the spool frame. In various embodiments the first and second frame portions each include a first face and second face, and a sidewall extending between the first and second faces. In one or more embodiments the first and second frame portions each include a plurality of vehicle mounting holes for fastening the modular winch system to a vehicle, the vehicle mounting holes extended through the sidewall, approximately parallel with the first and second face.

In one or more embodiments the first and second frame portions each include a secondary mounting hole extended partially through the sidewall approximately perpendicular to the vehicle mounting holes, and a spool aperture for rotatably supporting an end of the spool, the spool aperture extended through the first and second face approximately parallel with the sidewall.

In one or more embodiments the first frame portion includes a motor module connection interface configured to mount a winch motor selected from a plurality of different winch motors. In various embodiments the motor module connection interface includes a plurality of winch module attachment holes extended through the first and second face approximately parallel with the sidewall, the plurality of attachment holes circumferentially spaced about the spool aperture and defining at least two pairs of attachment holes, each pair of attachment holes corresponding to a different rotational orientation about the spool aperture for an attached winch motor.

In various embodiments the second frame portion includes a gearbox module connection interface configured to mount a winch gearbox selected from a plurality of different winch gearboxes. In one or more embodiments the gearbox module connection interface includes a plurality of winch module attachment holes extended through the first and second face approximately parallel with the sidewall, the plurality of attachment holes circumferentially spaced about the spool aperture and defining at least two pairs of attachment holes, each pair of attachment holes corresponding to a different rotational orientation about the spool aperture for an attached winch gearbox.

In various embodiments the winch assembly further includes a plurality of winch modules including a winch motor, a winch gearbox, and a fairlead each connected to the spool frame. In one or more embodiments the motor is attached to the motor module connection interface and has a rotational orientation defined by one of the pair of attachment holes and the gearbox is attached to the gearbox module connection interface and has a rotational orientation defined by one of the pair of attachment holes;

In various embodiments the spool frame is attachable to the vehicle in at least two orientations including a horizontal orientation where the plurality of mounting holes are approximately horizontal relative to the earth, and a vertical mounting orientation where the plurality of mounting holes are approximately vertical relative to the earth. In various embodiments, when attached to a vehicle in the horizontal orientation the fairlead is attached to the spool frame via the plurality of vehicle mounting holes of the first and second frame portions and the top plate is attached to the spool frame via the secondary mounting hole of the first and second frame portions. In one or more embodiments, when in the vertical orientation, the top plate is attached to the spool frame via the plurality of vehicle mounting holes and the fairlead is attached to the spool frame via the secondary mounting hole of the first and second frame portions.

One or more embodiments of the disclosure are directed to a winch hook bump-stop. In various embodiments, the winch hook bump-stop is a component that is designed to be attached to a winch rope, typically positioned just rearward of the winch hook but forward of a fairlead or rollers. In such embodiments, the bump-stop functions to prevent damage to the hook, fairlead, rollers, or other component, by preventing the metal hook from being pulled directly against the fairlead or rollers. In various embodiments, the winch hook bump-stop is additionally equipped with a lighting array positioned in a forward face of the bump-stop. The lighting array can include one or more lighting elements and a battery configured as a local power source for the lighting elements. In such embodiments the lighting elements are configured to emit light in a forward direction, for example while an operator is using the winch hook, for illuminating an object or area of interest forward of the bump stop body. As such, various embodiments provide an advantage for operating a winch or winch hook in low light or no light conditions. For example, various embodiments can provide an advantage for operating the winch in night-time conditions, off-road vehicle recoveries, or in other conditions where operators may face challenges and/or hazards in locating the correct hook and tackle locations without illumination. Further, because the lighting array is integrated into the Winch Hook bump Stop various embodiments provide a device that is easy to hold and direct light to the hard-to-see recovery connections without requiring the use of two hands or a separate lighting device such as a flashlight.

In one or more embodiments, the winch hook bump-stop comprises a bump stop body having a sidewall extending between an annular forward face and an annular rearward face, the sidewall defining an exterior surface and an interior space between the annular forward and rearward faces, the annular forward face and the annular rearward face defining a pathway through the bump stop body for passage of a winch rope along a rope axis. In one or more embodiments, the bump-stop comprises a lighting array positioned in the forward annular face. In various embodiments the lighting array includes one or more lighting elements and a battery configured to power the lighting elements. In such embodiments the one or more lighting elements are configured to emit light in a forward direction for illuminating objects forward of the bump stop body. In one or more embodiments the bump stop body includes one or more charging contacts positioned in the rearward face and a metal spring positioned in the interior space. In various embodiments the spring is attached to one of the forward face and the rearward face. In one or more embodiments the spring extends at least partially towards the other of the forward face and the rearward face. In various embodiments the metal spring is configured to electrically connect the battery and the one or more charging contacts. In certain embodiments the metal spring is configured to electrically connect the battery and the one or more charging while also being compressible along the rope axis with the bump stop body.

In one or more embodiments a fairlead can be included with the winch hook bump-stop. In various embodiments the fairlead includes a forward-facing surface having one or more charging contacts. In various embodiments the one or more charging contacts of the fairlead are configured to connect to the one or more charging contacts in the rearward face of the bump stop body. In such embodiments the fairlead and the metal spring are configured to electrically connect the battery to a power supply for charging the battery.

In one or more embodiments a first magnet can be positioned in the rearward face of the bump stop body and a second magnet and/or magnetic switch can be positioned in the forward face of the fairlead. In such embodiments the magnetic switch can be configured to be triggered by the first magnet when the rearward face of the bump stop body contacts the forward surface of the fairlead. In various embodiments a controller can be coupled with the magnetic switch. In one or more embodiments the controller is configured to output a signal for instructing a winch motor to automatically stop operation when triggered. In such embodiments, the controller, fairlead, and bump stop can configure the winch for auto-stop functionality, stopping the winch at end of the pull or plow lift to prevent over-winding and damage to the winch or recreational vehicle.

In certain embodiments the second magnet is configured to align the electrical contacts on the fairlead and the bump-stop for electrically connecting the battery with a power source connected to the fairlead.

The above summary is not intended to describe each illustrated embodiment or every implementation of the present disclosure.

### BRIEF DESCRIPTION OF THE SEVERAL VIEWS OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 is a front perspective view of a recreational vehicle having a modular winch assembly, according to one or more embodiments of the disclosure.

FIG. 2A is a front perspective view of a modular winch assembly, according to one or more embodiments of the disclosure.

FIG. 2B is a rear perspective view of the modular winch assembly of FIG. 2A, according to one or more embodiments of the disclosure.

FIG. 2C is a partially exploded view of the modular winch assembly of FIG. 2A depicting how fasteners are inserted through the spool frame, according to one or more embodiments of the disclosure.

FIG. 3A is a functional side view of a spool frame in a horizontal mounting orientation mounted to a vehicle, according to one or more embodiments of the disclosure.

FIG. 3B is a functional side view of a spool frame in a horizontal mounting orientation mounted to a vehicle, according to one or more embodiments of the disclosure.

FIG. 4A is a functional top-down view of the modular winch assembly components, according to one or more embodiments of the disclosure.

FIG. 4B-4F is a functional top-down view of a variety of modular winch assembly permutations, according to one or more embodiments of the disclosure.

FIG. 5 is a forward perspective view of a winch hook bump-stop, according to one or more embodiments of the disclosure.

FIG. 6 is a front view of a winch hook bump-stop, according to one or more embodiments of the disclosure.

FIG. 7 is a rear view of a winch hook bump-stop, according to one or more embodiments of the disclosure.

FIG. 8 is a cross-sectional view of a winch hook bump-stop, according to one or more embodiments of the disclosure.

FIG. 9 depicts a partial front perspective of a vehicle with a winch, a plow, and a winch and plow control system, according to one or more embodiments of the disclosure.

FIG. 10 depicts a display module for a winch and plow control system, according to one or more embodiments of the disclosure.

FIG. 11A depicts a schematic block diagram a winch and plow control system, according to one or more embodiments of the disclosure.

FIG. 11B depicts a current load diagram for an ECM in a winch and plow control system, according to one or more embodiments of the disclosure.

FIG. 12 depicts a method of winch mode operation for the winch and plow control system, according to one or more embodiments of the disclosure.

FIGS. 13A and 13B depict methods of operation are depicted for the winch and plow control system, according to one or more embodiments of the disclosure.

FIG. 14 depicts a stranded vehicle and a recovery vehicle in a networked vehicle to vehicle recovery mode for the winch and plow control system, according to one or more embodiments of the disclosure.

FIG. 15 depicts a method of operating a vehicle-to-vehicle recovery mode for the winch and plow control system, according to one or more embodiments of the disclosure.

FIG. 16 depicts a method of operation for the winch and plow control system, according to one or more embodiments of the disclosure.

FIG. 17 depicts a schematic block diagram a winch and plow control system, according to one or more embodiments of the disclosure.

FIG. 18 depicts a vehicle having a winch assembly and a cable shim, according to one or more embodiments of the disclosure.

FIGS. 19 and 20 depict a winch assembly retracting a cable having a cable shim into a spool, according to one or more embodiments of the disclosure.

FIG. 21 depicts a top-down view of a cable shim, according to one or more embodiments of the disclosure.

FIG. 22 depicts a schematic block diagram a winch and plow control system with an installed plow mode upgrade kit, according to one or more embodiments of the disclosure.

FIG. 23 depicts an upgrade kit for legacy vehicle platforms, according to one or more embodiments of the disclosure.

FIG. 24 depicts a method of installing a plow mode upgrade kit, according to one or more embodiments of the disclosure.

FIG. 25 depicts a dashboard of a recreational vehicle having a winch control system, according to one or more embodiments of the disclosure.

While the embodiments of the disclosure are amenable to various modifications and alternative forms, specifics thereof have been shown by way of example in the drawings and will be described in detail. It should be understood, however, that the intention is not to limit the disclosure to the particular embodiments described. On the contrary, the intention is to cover all modifications, equivalents, and alternatives falling within the spirit and scope of the disclosure.

### DETAILED DESCRIPTION

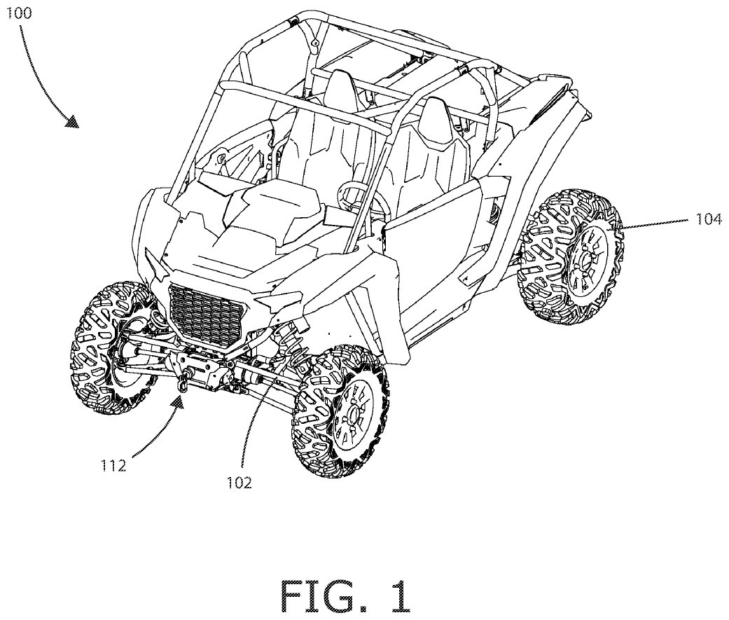

Referring to FIG. 1, a front perspective view of a recreational vehicle 100 is depicted with a modular winch assembly 112. In one or more embodiments the vehicle 100 is an all-terrain vehicle (ATV), a utility terrain vehicle (UTV), or other type of off-road vehicle (ORV). However, in various embodiments the vehicle 100 could include other types of vehicles, including, but not limited to, boats, motorcycles, or other recreational vehicles. In certain embodiments the winch assembly 112 could be paired with non-recreational vehicles. For example, in certain embodiments the winch assembly 112 could be paired with a truck, car, or the like. Depicted in FIG. 1, the vehicle 100 is shown generally to include a frame 102 supported by a plurality of wheels 104. The vehicle 100 includes a front end having a hood, an engine (not shown), and the winch assembly 112 coupled to the frame 102. In various embodiments the winch assembly 112 may be directly coupled to the frame 102. In certain embodiments the winch assembly 112 could be mounted to a bumper. The winch assembly 112 may be powered by a vehicle battery, alternator, and/or any appropriate power source.

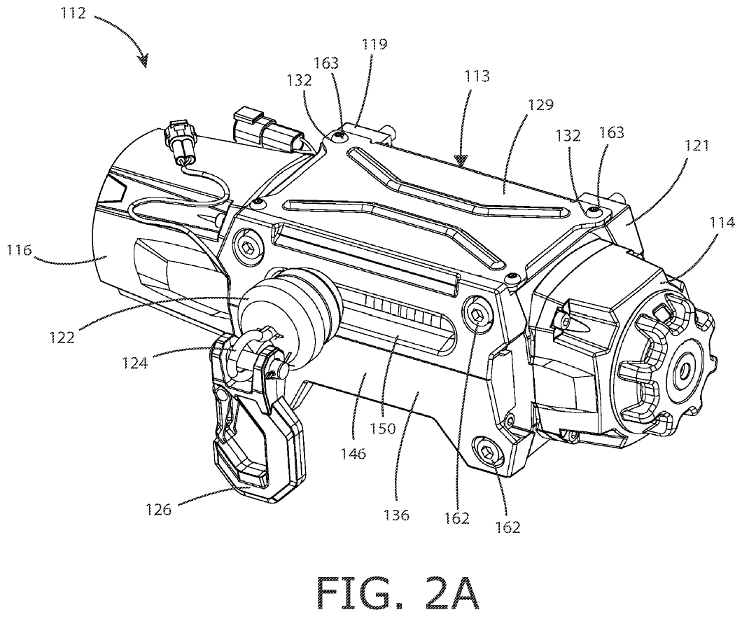

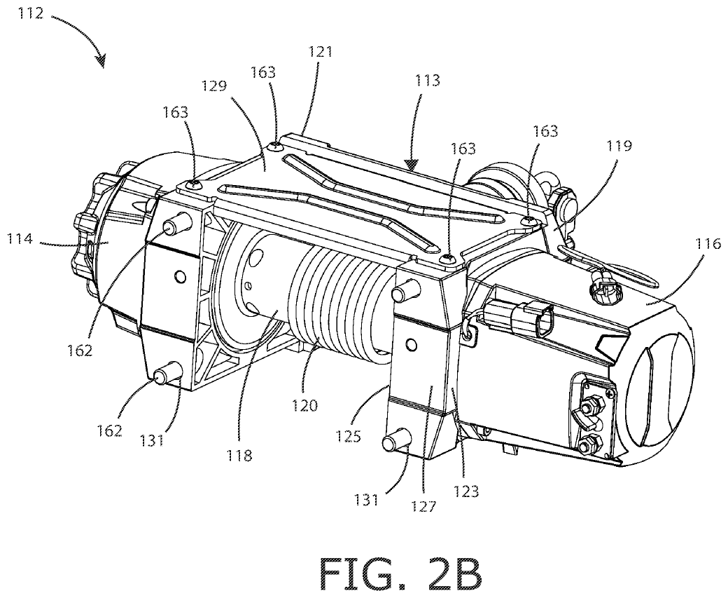

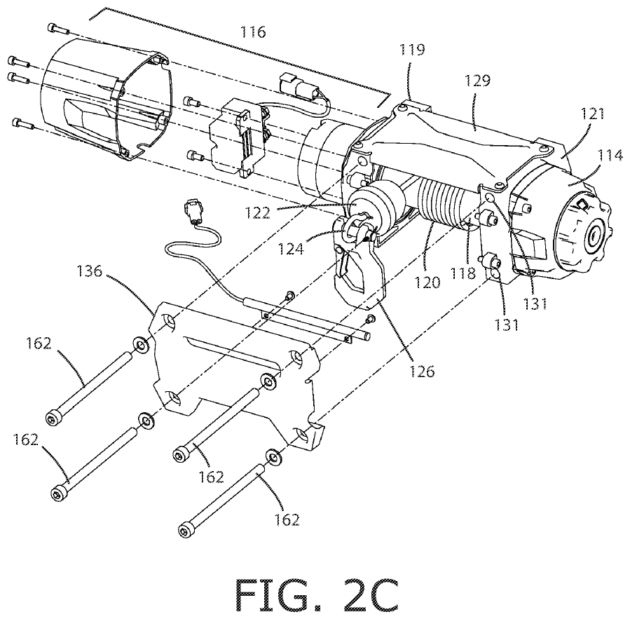

Referring to FIGS. 2A-2C, views of the modular winch assembly 112 are depicted according to one or more embodiments. In various embodiments the winch assembly 112 includes a spool frame 113, a gearbox 114, a motor 116, a spool 118, and a fairlead 136. In various embodiments the spool frame 113 is a structural support that contains and rotatably supports the spool 118 and forms a mounting surface for the gearbox 114, motor 116, and the fairlead 136. In one or more embodiments the spool frame 113 includes a first frame portion 119 and a second frame portion 121 configured to rotatably support the spool 118 between the two frame portions 119, 121. In such embodiments each of the frame portions 119, 121 include a first face 123 and a second face 125 and a sidewall 127 that extends between the two and defines the overall shape of the frame portions 119, 121. Depicted herein, the frame portions are generally a rectangular prism having a sidewall 127 with four distinct sides. However, in various embodiments the sidewall 127 could have a larger or smaller number of distinct sides. For example, in certain embodiments, the sidewall 127 could define a generally cylindrical shape for each frame portion 119, 121. In various embodiments the spool frame 113 further includes a top plate 129 connecting the first and second frame portions 119, 121 and defining a top side of the spool frame 113.

Described further below, the frame portions 119, 121 are designed each having a plurality of universal mounting locations and/or interfaces for connecting various part groupings and winch modules such that, in one or more embodiments the motor 116, gearbox 114, fairlead 136, and top plate 119, can be attached to the spool frame in a variety of positions and/or rotational orientations. As such, in various embodiments, the first and second frame portions 119, 121 each include a plurality of vehicle mounting holes 131 that extend through the sidewall 127, approximately parallel with the first and second face 123, 125. In one or more embodiments the first and second frame portions 119, 121 include a secondary mounting hole extended partially through the sidewall 127 approximately perpendicular to the vehicle mounting holes 131. In various embodiments the first and second frame portions include a spool aperture for rotatably supporting the spool. In one or embodiments the spool aperture is extended through the first and second face 123, 125 approximately parallel with the sidewall 127.

In various embodiments, the first frame portion includes a motor module connection interface configured to mount a winch motor selected from a plurality of different available winch motors. In such embodiments the motor module connection interface includes a plurality of winch module attachment holes extended through the first and second face approximately parallel with the sidewall 127. In various embodiments the plurality of attachment holes circumferentially spaced about the spool aperture and define at least two pairs of attachment holes, each pair of attachment holes corresponding to a different rotational orientation about the spool aperture for attaching a winch motor to the spool frame.

In one or more embodiments the second frame portion includes a gearbox module connection interface configured to mount a winch gearbox selected from a plurality of different available winch gearboxes. In one or more embodiment the gearbox module connection interface includes a plurality of winch module attachment holes extended through the first and second face approximately parallel with the sidewall, the plurality of attachment holes circumferentially spaced about the spool aperture and defining at least two pairs of attachment holes. In such embodiments each pair of attachment holes corresponds to a different rotational orientation about the spool aperture for attaching a winch gearbox.

For example, in various embodiments the motor 116 is attached to the first frame portion 119 and has a rotational orientation defined by one of the pair of attachment holes. Similarly in one or more embodiments the gearbox 114 is attached to the second frame portion 121 and has a rotational orientation defined by one of the pair of attachment holes.

In one or more embodiments the spool 118 extends between the first and second frame portion 119, 121 and from the gearbox 114 to the motor 116. In various embodiments the spool 118 can have different lengths depending on the type of spool used. In such embodiments, the frame portions 119, 121 can be placed closer together or farther apart based on the width of the spool to enable manufacturing options for rope diameter and length based on vehicle constraints and anticipated customer needs.

In various embodiments the motor 116 is configured to provide power to the gearbox 114, and the gearbox 114 is configured to rotate the spool 118. In certain embodiment, the motor 116 may be a brushless direct current (DC) motor, a standard DC motor, or other motor type as required or desired for a particular application. In one or more embodiments, the spool frame 113 provides a universal mounting surface via the frame portions such that the motor 116 can be easily attached to the spool frame 113 regardless of the type of motor used or the rotational orientation of the motor required to fit the motor in the space available when mounting the modular winch 112. In one or more embodiments the motor 116 is an electrical motor powered by energizing a copper coil with DC electrical power. As such, in various embodiments an electrical connector 128 extends from the motor 116. In one or more embodiments the electrical connector 128 may transmit high-current power to the motor 116 from a power source, for example, a battery or generator (not shown) of the vehicle 100.

The gearbox 114 may provide a speed reduction such that the rotational speed of the motor 116, which is the input to the gearbox 114, is reduced to a lower rotational speed of the spool 118, which is the output of the gearbox 114. In some embodiments, the gearbox 114 may be a single-stage reduction accomplished with a single set of gears, while other embodiments may use multi-stage reductions accomplished with multiple sets of gears. Gearbox 114 may use planetary type gearsets for single or multi-stage reductions. In one or more embodiments, the spool frame 113 provides a universal mounting surface via the frame portions such that the gearbox 114 can be easily attached to the spool frame 113 regardless of the type of gearbox used or the rotational orientation required to fit the gearbox 114 in the space available when mounting the modular winch 112.

In various embodiments a rope or cable 120 is wrapped around the spool 118. The cable 120 may wind-up, or un-wind from the spool 118, depending on the rotation of the spool 118 (e.g., the rotation applied by the gearbox 114, when the gearbox 114 receives power from the motor 116). In various embodiments the rope 120 includes a winch hook 124 extending therefrom. A load hook 126 may be attached to the winch hook 124 (e.g., via a pin lock mechanism, or hooked attachment). When the winch assembly 112 is in use, the load hook 126 may be attached to a load (e.g., a vehicle to be towed, or an object to be pulled towards vehicle 100, or towards which the vehicle 100 is to be pulled). In such embodiments the motor 116 may be activated to drive the gearbox 114, such that the spool 118 rotates, the rope or cable 120 is wound-up around the drum, and the winch head 122 and load hook 126 are pulled towards the spool 118, thereby closing the distance between the vehicle 100 and the load hook 126, together with any structure to which hook 126 may be attached.

Described further below, in various embodiments the rope 120 includes a winch hook bump-stop 122. In various embodiments, the winch hook bump-stop 122 is a component that is designed to be attached to a winch rope 120, typically positioned rearward of a winch hook 124 but forward of the fairlead 136. In various embodiments, and described further below, the winch hook bump-stop 122 includes a bump stop body that is constructed from a generally compressible material, such as rubber, plastic, or the like, that allows the bump-stop 122 to prevent damage to the hook 124, fairlead 136, vehicle 100, or other component by providing a cushion between the hook 124 and the other components.

In one or more embodiments the fairlead 136 may be structurally integrated with the spool frame 113. For example, when the winch assembly 112 is in use, the fairlead 136 may absorb stresses or strains generated by the cable 120 winding, or unwinding, from the spool 118. In certain embodiments the fairlead 136 forms a load-bearing component of the winch assembly 112 and is designed to directly provide the torsional rigidity of the assembly 112. However, in certain embodiments, the modular winch assembly 112 does not include a fairlead 136. In one or more embodiments the fairlead 136 includes a front or exterior fairlead face 146 and a rear or interior fairlead face. The first fairlead face 146 is an exterior face. The second fairlead face is an interior face that abuts the front housing side 140, when the winch assembly 112 is assembled as shown in FIG. 1C. The fairlead 136 includes a first slot 150 that extends longitudinally with the spool 118. The first slot 150 extends through the fairlead 136 from the front fairlead face 146 to the rear fairlead face. In various embodiments the rope or cable 120 extends through the first slot 150, at least when the winch assembly 112 is in use (e.g., winding in, or winding out, a load).

In one or more embodiments the modular winch 112 is an assembly of parts and/or winch modules that are fixed to the spool frame 113 by fasteners, such as by bolted connections. As described above, in various embodiments the spool frame 113 includes a first frame portion 119 and a second frame portion 121. In various embodiments the first and second frame portions define two endcaps having the motor 116 and the gearbox 114 respectively fixed thereto. For example, in various embodiments the motor 116 is attached to the first frame portion 119 and has a rotational orientation defined by one of the pair of attachment holes of the first frame portion 119. Similarly the gearbox 114 is attached to the second frame portion 121 and has a rotational orientation defined by one of the pair of attachment holes of the second frame portion 121.

In one or more embodiments the winch assembly 112 includes one or more fasteners 162, 163 (e.g., bolts, screws, or rivets) that connect the fairlead 136 and/or the top plate 129 to the spool frame 113. In various embodiments the fasteners 162 further connect the spool frame 113 to a vehicle frame, such as on the vehicle 100. For example, in one or more embodiments the spool frame 113 includes the plurality of vehicle mounting holes 131 for fastening the modular winch system to the vehicle 100 and for mounting one of the fairlead 136 and the top plate 129, depending on the rotational mounting orientation of the spool frame 113. For example, depicted in FIGS. 2A-2C, the fairlead 136 is shown connected via the vehicle mounting holes 131 with the fasteners 162 extended from the front fairlead face 146, through the fairlead 136, through the housing 134, and that exit the housing 134 and protrude beyond the rear surface 143 for connection to a vehicle. However, in certain embodiments, and discussed further below, the top plate 129 could be connected via the vehicle mounting holes 131. In one or more embodiments secondary mounting holes 132 in each of the frame portions allow for mounting one of the top plate 129 and the fairlead 136. For example, depicted in FIG. 2A-2C the top plate 129 is mounted via the secondary mounting holes 132. However, in certain embodiments the fairlead 136 could instead by connected via the secondary mounting holes 132.

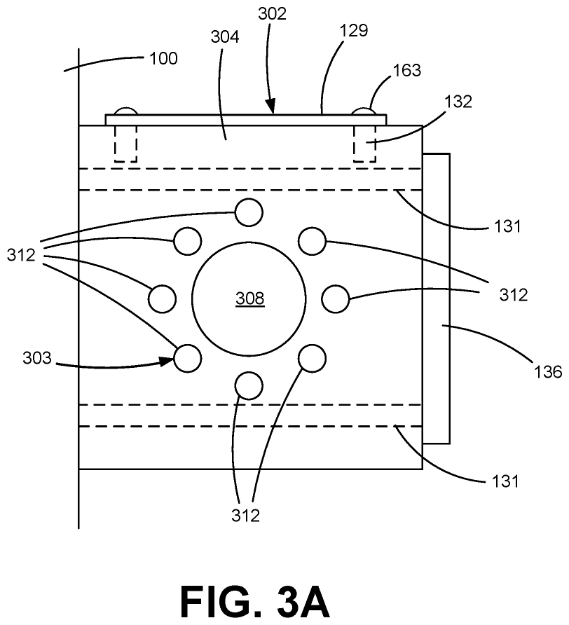

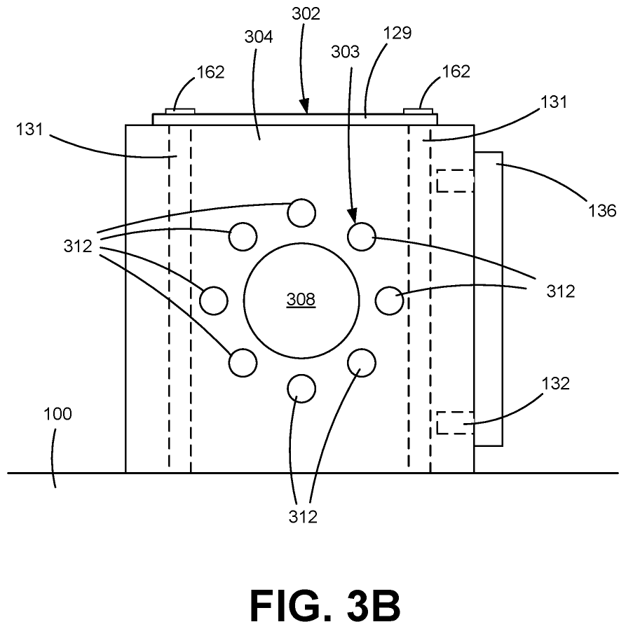

Referring to FIGS. 3A and 3B a functional side views of a spool frame are depicted. Specifically, FIGS. 3A and 3B depict a side view of a frame portion 302 of the spool frame configured in a horizontal and vertical mounting orientation connected to a vehicle 100, respectively. As described above, the frame portion includes a plurality of universal mounting locations and interfaces for the various part groupings of the modular winch. For example, frame portion 302 includes a plurality of vehicle mounting holes 131 for fastening the modular winch system to the vehicle 100, one or more secondary mounting holes 132 extended partially through the sidewall approximately perpendicular to the vehicle mounting holes 131, a spool aperture 304 for rotatably supporting the spool, and a plurality of winch module attachment holes 312.

In one or more embodiments the frame portion includes a motor module connection interface configured to mount a winch motor selected from a plurality of different winch motors and/or a gearbox module connection interface configured to mount a winch gearbox selected from a plurality of different winch gearboxes. Depicted in FIGS. 3A and 3B the motor module connection interface and gearbox module connection interface are included as embodiments of a winch module connection interface 303.

In one or more embodiments the winch module connection interface includes the module attachment holes 312 circumferentially spaced about the spool aperture 308 and defining two or more hole pairs, where each attachment hole pair allows for the attachment of a winch module such as a gearbox or motor. In one or more embodiments, each hole pair is rotated relative to one another about the center of the spool aperture such that each pair of attachment holes corresponds to a different rotational orientation for winch module to be attached to the spool frame 302. Depicted in FIGS. 3A and 3B, the plurality of module attachment holes 312 include at least eight attachment holes that in turn define at least four pairs of attachment holes. In such embodiments, these attachment holes result in at least sixteen rotational orientations for an attached winch module. However, in various embodiments the frame portion 304 could include additional attachment holes 312 or fewer attachment holes. In one or more embodiments, each of the attachment hole pairs are rotated from one another approximately 90 degrees, such that an attached winch module can have its rotational orientation incremented by 45 degrees, as desired by the manufacturer or user. In some embodiments, each of the attachment hole pairs are rotated from one another approximately 45 degrees, such that an attached winch module can have its rotational orientation incremented by 45 degrees, as desired by the manufacturer or user.

In such embodiments the motor and gearbox are independently rotatable when attached to the frame 304. In such embodiments the gearbox and motor can be rotated to account for or position various user features on the gearbox and motor to ensure that those features remain accessible to a user regardless of the design of the vehicle or bumper where the winch assembly is mounted. For example, in one or more embodiments the gearbox includes a freespool handle projecting outwardly, where the rotational orientation of the gearbox defines the rotational orientation of the freespool handle. Similarly, as described above, in various embodiments the motor includes a power terminal projecting outwardly. In such embodiments the motor defines the rotational orientation of the power terminal. In these embodiments the rotational orientation of the motor and or gearbox can depend on the accessibility of these outwardly projecting features, with the gearbox and motor rotated appropriately such that these features remain accessible to a user regardless of any surrounding structure or obstructions.

In various embodiments the spool frame 302 is attachable to the vehicle 100 in at least two orientations including a horizontal orientation where the plurality of mounting holes 312 are approximately horizontal relative to the earth, and a vertical mounting orientation where the plurality of mounting holes are approximately vertical relative to the earth. Depicted in FIG. 3A, the spool frame 302 is shown in the horizontal mounting orientation. Depicted in FIG. 3B the spool frame 302 is shown in the vertical mounting orientation. In various embodiments the rotational orientation of the spool frame 302 determines the placement of the fairlead 136 and the top plate 129. For example, in various embodiments in the horizontal orientation the fairlead 136 is attached to the spool frame via the plurality of vehicle mounting holes 131 of the first and second frame portions and the top plate is attached to the spool frame via the secondary mounting holes 132 of the first and second frame portions. In certain embodiments in the vertical orientation the top plate 129 is attached to the spool frame 302 via the plurality of vehicle mounting holes 131 and the fairlead 136 is attached to the spool frame 302 via the secondary mounting holes 132.

In such embodiments, the mounting holes 131, 132 allow for the fairlead 136 and top plate 129 to be shifted to keep the fairlead 136 generally horizontal relative to the earth for guiding the rope and the top plate 129 to be shifted to remain as the topmost feature of the modular winch. In such embodiments the fairlead 136 and top plate 129 maintain their positions, relative to the earth, while the spool frame 302 and the mounting holes can be rotated to select the most desirable mounting configuration for the user.

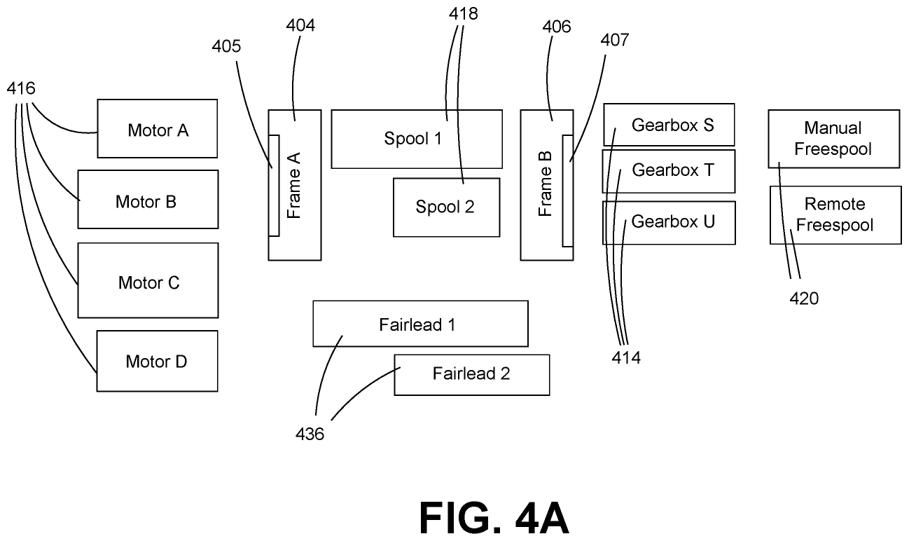

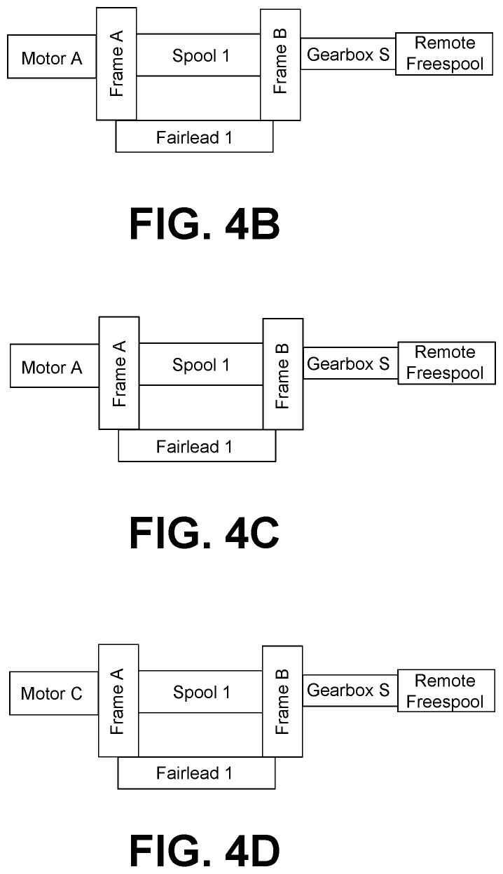

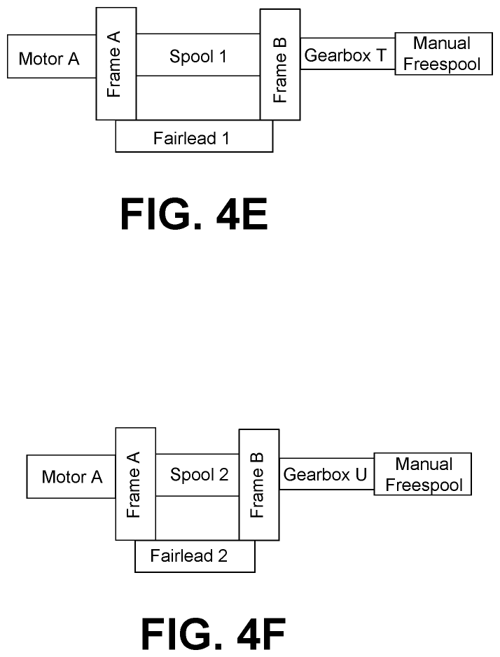

FIG. 4A is a functional top-down view of a collection of modular winch components, according to one or more embodiments of the disclosure. As described above, in various embodiments the modular winch architecture a spool frame including a first and second frame portion 404, 406 each having a plurality of universal mounting locations and interfaces for the various part groupings. As such, in various embodiments the first and second frame portions are generally interchangeable such that the frame portion does not limit the type of motor 416, gearbox 414, spool 418, fairlead 436, freespool 420, or other component of the modular assembly. FIG. 4A depicts the frame portions 404, 406 with a collection of these components, showing the flexibility of the spool frame platform described herein. In certain embodiments based on known or anticipated configurations of the components in this system, at least 48 base configurations of winches could be made, not accounting for differences in fairlead style, rope type, presence of Auto-stop, presence of wireless winch control, or other options.

For example, in various embodiments, the first frame portion 404 includes a motor module connection interface 405 configured to mount a winch motor selected from a plurality of different available winch motors 416. Similarly, the second frame portion 406 includes a gearbox module connection interface 407 configured to mount a winch gearbox selected from a plurality of different available winch gearboxes 414. Various embodiments enable many permutations of features to customize the winch to the use case that best suits the vehicle it will be used on and allow further customization of the winch by the user with any parts in this ecosystem. In such embodiments it will also allow simpler service, including more straightforward service parts, increasing the likelihood that a dealer will have the right service parts in stock. Greater manufacturing flexibility will also enable as many configurations as possible of winches that can be built from a set number of parts. This also simplifies the design of the chassis components that will support the winch. For example, FIG. 4B-4F depict a variety of examples, modular winch assembly permutations, according to one or more embodiments of the disclosure. The embodiments and permutations herein depict different combinations of motors, gearboxes, spools having different spool lengths, and freespools. In addition, in various embodiments the motors 416 and/or gearboxes 414 can each have one or more of a different size, a different connection interface, and a different type of motor.

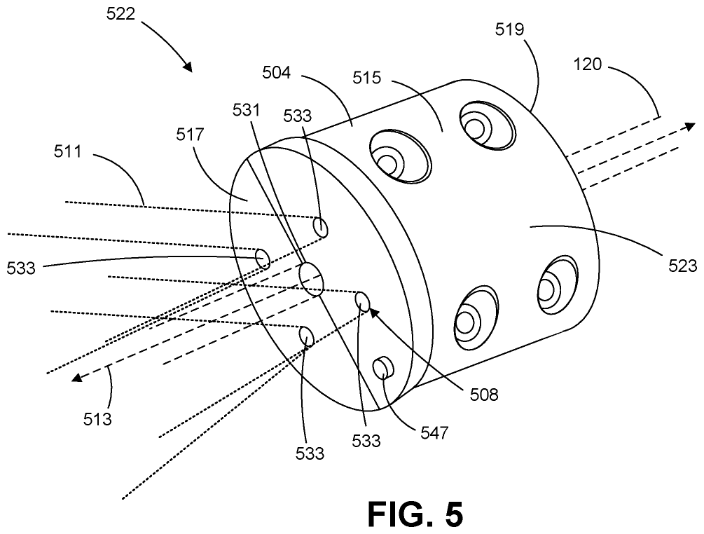

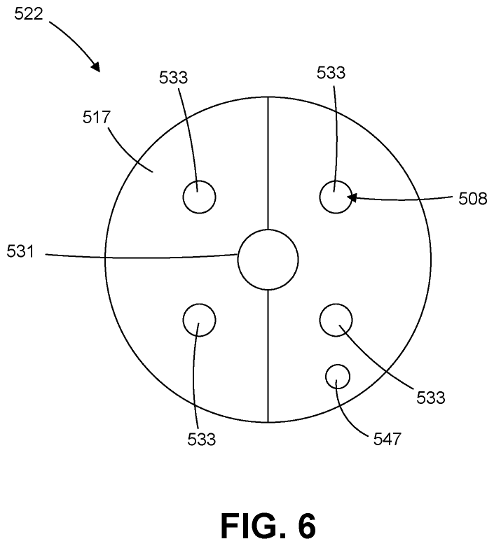

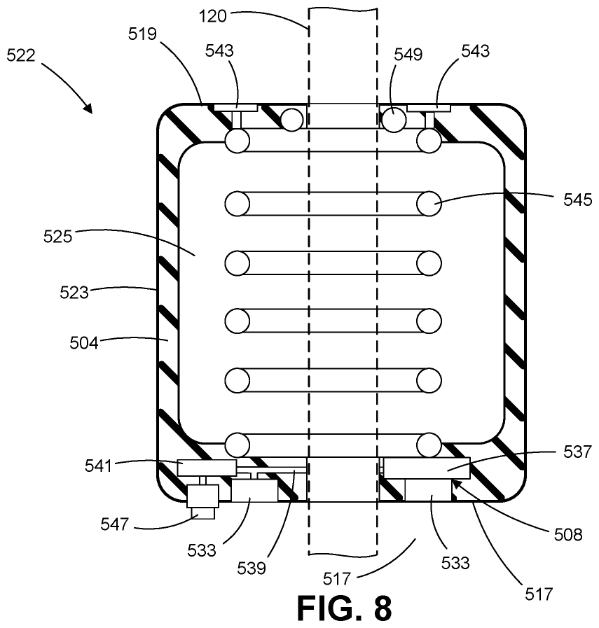

Referring additionally to FIGS. 5-8 views of a winch hook bump-stop 522 are depicted, according to one or more embodiments of the disclosure. In various embodiments, the winch hook bump-stop 522 is a component that is designed to be attached to a winch rope 120, typically positioned rearward of a winch hook 126 but forward of the fairlead 136 or rollers. For example, in various embodiments bump-stop 122 could be the winch hook bump-stop 522 described below.

Referring to FIGS. 5-8, In various embodiments the winch hook bump-stop 522 includes a bump stop body 504 that is constructed from a generally compressible material, such as rubber, plastic, or the like, that allows the bump-stop 522 to prevent damage to the hook, fairlead, rollers, recreational vehicle, or other component by providing a cushion between the hook and other winch components.

In various embodiments, the bump stop body 504 includes a lighting array 508 including one or more lighting elements 510 that are configured to emit light, for example while an operator is using the winch hook, for illuminating an object or area of interest to assist in winch operation. For example, depicted in FIG. 5, the lighting elements 510 are depicted emitting light 511 forwardly in a direction generally parallel with a rope axis 513 that extends lengthwise through the bump-stop body 504.

In one or more embodiments, the bump stop body 504 includes a sidewall 515 that extends between a forward face 517 and a rearward face 519. In such embodiments, the sidewall 515, and the forward and rearward face 517, 519 define the overall shape for the bump stop body 504. Depicted in FIGS. 5-8, the bump stop body 504 is generally cylindrical. However, in certain embodiments the bump stop body 504 could have various other shapes. For example, the bump stop body 504 could be a prism where the forward and rearward face define the base for the prism and the sidewall is composed of a plurality of side portions.

In one or more embodiments the sidewall 515 defines an exterior surface 523 and defines an interior space 525 within the winch hook bump-stop 522 that extends between the forward and rearward faces 517, 519. In such embodiments the interior space 525 allows the bump stop body 504 to house various components and/or allow the winch rope 120 to pass through the winch hook bump-stop 522. In various embodiments the forward face 517 and the rearward face 519 are annular faces, each having a rope aperture 531. In such embodiments the interior space 525 and the annular forward and rearward face together define a pathway along the rope axis 513 through the bump stop body for passage of the winch rope 120.

In various embodiments, the lighting array 508 includes one or more lighting elements 533 and a battery 537 that is electrically coupled with the one or more lighting elements 533 and configured to locally supply power. For example, in one or more embodiments the battery 537 is electrically connected to the one or more lighting elements 533 via a wired connection 539. In various embodiments the lighting array 508, battery 537, lighting elements 533, and wired connection 539 can be overmolded into the first face 517. In various embodiments the one or more lighting elements 533 are LEDs. In one or more embodiments, the lighting array 508 can include a controller 541. In such embodiments the controller 541 can perform various logical functions for the lighting array 508. For example, in one or more embodiments the controller 541 can be configured to provide voltage regulation, lighting control, color control, on/off conditions, or other logical functions.

In one or more embodiments the one or more lighting elements 533 of the lighting array are positioned in the forward face 517 and directed forwardly for illumination of objects or areas of interest forward of the bump-stop body. In one or more embodiments the lighting elements can be circumferentially spaced about the aperture 531 for more even illumination regardless of the position of the bump stop body 504. In various embodiments, the battery 537, controller 541, and any other components of the lighting array 508 can be positioned with the lighting elements 533 or in another part of the bump stop body 504. For example, in various embodiments the various components of the lighting array 508 can be positioned in the interior space 525, such as an on an interior surface of the forward or rearward face, and electrically connected via wiring, metal spring, or the like. In certain embodiments the various components of the lighting array 508 are overmolded into the bump stop body 504, for example overmolded into the forward face 517 and/or rearward face 519.

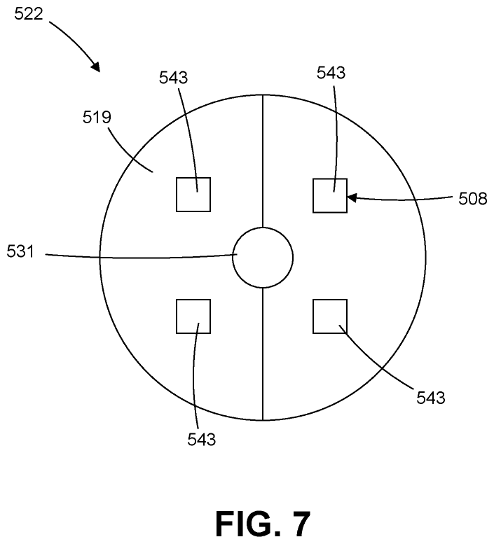

In one or more embodiments the winch hook bump-stop 522 includes one or more charging contacts 543. In such embodiments the one or more charging contacts 543 are electrically connected to the battery 537 to allow for recharging when the contacts are connected to a suitable power source. For example, in one or more embodiments the charging contacts 543 can be positioned on the rearward face 519 of the bump stop body 504 and can be configured to connect to one or more corresponding other charging contacts on a fairlead 136 or other surface that are in turn electrically connected to a larger battery, alternator, or other power source for charging battery 537. Depicted in FIG. 7, in various embodiments the bump stop 522 includes a plurality of charging contacts. In such embodiments the plurality of contacts can be circumferentially arranged about the aperture 531 such that the contacts can make electrical contact with a corresponding fairlead charging contact regardless of the rotational orientation of the bump-stop body 522.

In one or more embodiments the battery 537 and the charging contacts 543 are electrically connected via a metallic spring 545 that is positioned in the interior space of the bump-stop body 504. In one or more embodiments the metallic spring 545 is overmolded into one or both of the forward face 517 and the rearward face 519 such that the spring 545 spans the distance between the faces to connect the charging contacts 543 and battery 537. In one or more embodiments the metallic spring 545 electrically connects the battery 537 such that the metal contacts are configured to electrically connect the battery 537 to an external power source. In one or more embodiments the metal spring is configured to electrically connect these elements while also being compressible with the bump stop body 504 along the rope axis 513. For example, in various embodiments the spring 545 allows for the bump stop body 504 to be compressed between the winch hook and the fairlead while maintaining the electrical connection and without being damaged by the force of compression. In certain embodiments, the metallic spring 545 additionally functions to provide further structural integrity to the bump-stop body 504 along the rope axis 513.

In one or more embodiments the lighting array 508 further includes a switch 547 configured to control power to the one or more lighting elements 533. In various embodiments the switch 547 can be positioned on one or more of the sidewalls 515, the forward face 517, and the rearward face 519. For example, depicted herein, the switch is a push-button switch positioned on the forward face 517 of the bump stop body 504.

In one or more embodiments the bump stop body further includes a magnet 549. In one or more embodiments the magnet 549 is positioned in the rearward face 519 of the bump stop body. For example, in certain embodiments the magnet 549 is a ring magnet overmolded with the metallic spring in the interior of the rearward face 519. In such embodiments, the ring magnet 549 provides a central aperture through the magnet to allow for placement about the winch rope. In various embodiments the magnet 549 functions to assist in charging operations by aligning with a corresponding second magnet in the fairlead, or a magnetic material in the fairlead, which in turn aligns charging contacts 549 of the rearward face 519 with charging contacts in the fairlead. For example, in various embodiments the magnet is positioned in the rear face 519 such that when the magnet 549 is pulled to the fairlead the one or more charging contacts of the fairlead are electrically connected with the one or more charging contacts of the bump stop body 504. For example, in one or more embodiments the fairlead could include a large charging contact that that is close to or adjacent to the fairlead slot. In such embodiments the magnet could align the contacts by bringing and/or holding the bump stop body against the fairlead when the two are in close proximity.

In certain embodiments, the magnet 549 additionally allows for auto-stop functionality. For example, in various embodiments a magnetic switch, such as a reed switch, can be included in the fairlead. The magnetic switch can be coupled with a controller that is configured to output a signal for instructing a winch motor to stop operation in response to the magnetic switch being triggered. For example, in various embodiments would be suitable for functioning with the existing Polaris® HD winch having the auto-stop feature that turns off the winch or plow mechanism as the winch rope is retracted. In certain embodiments the auto-stop feature includes the fairlead that uses a reed switch positioned in the front. In one or more embodiments the magnet 549, when positioned in proximity to the reed switch, causes the switch to close. This in turn turns off the winch motor by no longer delivering power to the winch motor through a winch contactor. In certain embodiments, the signal switch is also provided to a user display. Additional discussion of this auto-stop functionality can be found in U.S. Pat. No. 10,883,235, which is hereby incorporated by reference.

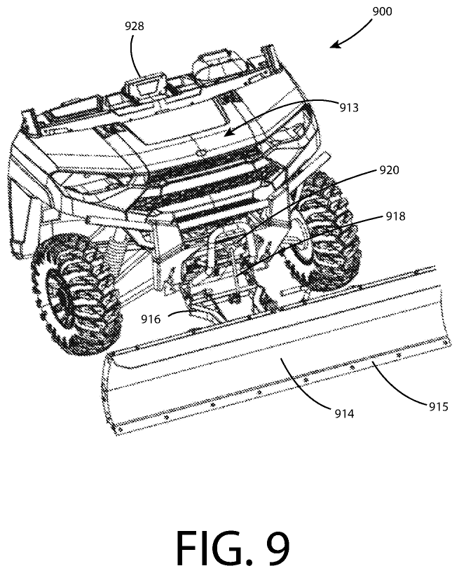

Referring now to FIG. 9, a partial front perspective of a vehicle 900 is depicted with a winch 920, a plow 914, and a winch and plow control system. As described above, the vehicle 900 may be any appropriate off-road, or recreational vehicle. However, it is understood that any appropriate type of vehicle can utilize a winch and plow control system. As illustrated in FIG. 9, a plow 914 is attached to the vehicle 900 by way of support arms 916 and is raised and lowered by way of a line 918, also referred to as a cable or rope. The line or cable 918 may be any appropriate line such as a polymer rope, natural fiber rope, steel cable, etc. The line 918 is attached to a winch 920 located within the front of the vehicle 900. Any plow or frame may be operated and controlled with the winch and plow control system. The vehicle 900 can include various standard components, such as those understood by one skilled in the art. For example, the vehicle includes an engine 913. Various components may further include an alternator or generator to generate electrical power and an energy storage system, such as a battery. The winch 920 may be powered by a battery, alternator and/or any appropriate power source.

In various embodiments a fairlead is positioned in the front of the vehicle 900. In one or more embodiments the fairlead may work with an auto-stop grommet and/or bump-stop, as described above. At the distal end of the cable 918 may be a hook that couples to the support arms 916 to enable the support arms 916 to raise and lower the plow 914, via the winch 920 and cable 918. To assist in control over the winch 920 and/or the plow 914, a control system may include a display 928 associated with the vehicle 900. The display 928 include an interface for a user of the vehicle 900 to control the winch 920, as well as raise and lower the plow 914. Also associated with the operation of the plow 914 can be an optional operator presence switch that can be embedded in a driver seat to optionally allow for raising and lowering the plow only during the presence of a driver or user in the vehicle 900 positioned within the driver seat.

As illustrated in FIG. 9, the plow 914 is shown in the down or lowered position, such as including portions or bumpers 915 that contact a surface or road. In this position, the plow 914 can be used to either push snow or debris when the vehicle 900 is moving forward. Alternatively, the plow 914 can be used to pull debris away from an area, such as a garage door, when the vehicle 900 is moving in reverse or backwards. In a raised or up position relative to the vehicle 900 the vehicle 900 can be moved either forward or in low gear or backwards or reverse gear to move to a desired location without the plow 914 engaging snow or debris.

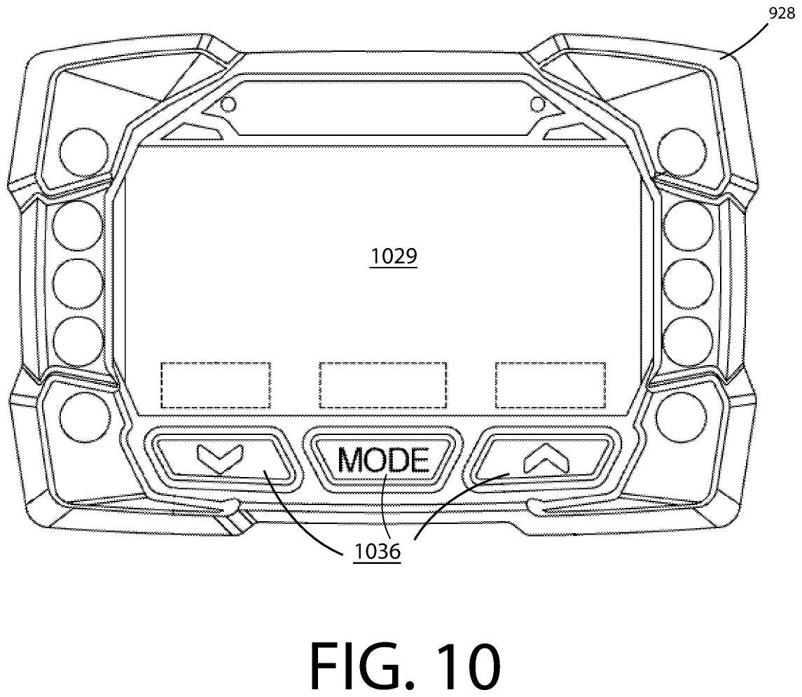

Referring additionally to FIG. 10, the display module 928, includes a display screen 1029 includes a physical button interface, which may include a three-button interface 1036 that may be used to control the winch 920 and plow 914. As illustrated in FIG. 10, the three-button switch 1036 includes a mode switch or button 1038 that can be toggled to switch between various modes for controlling the winch 920 and plow 914. Modes may include a winch mode, a plow mode, vehicle to vehicle winch networking, Get Me Out mode, or other mode. In various embodiments, by providing the display module 928, there is no need to provide a separate switch assembly for controlling the plow and the plow can be controlled, via another existing display module on the vehicle 900. The display module 928 may also provide other information to a user as discussed further herein including a vehicle speed, engine rotation per minute (RPM), fuel level, and engine parameters (e.g., engine temperature, pressure, etc.).

Accordingly, in a winch control mode, or “winch mode”, the winch can be controlled via the three-button interface 1036. For example, to spool the cable 918 either in or out, activate torque based free-spooling, and to increase engine idle/alternator output for increased winch power and/or torque.

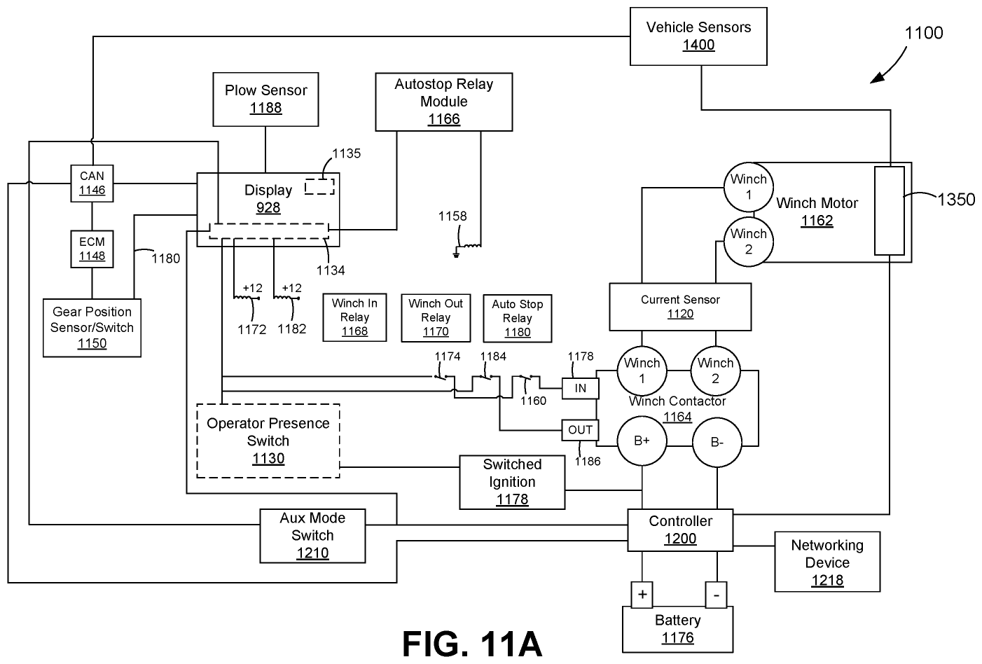

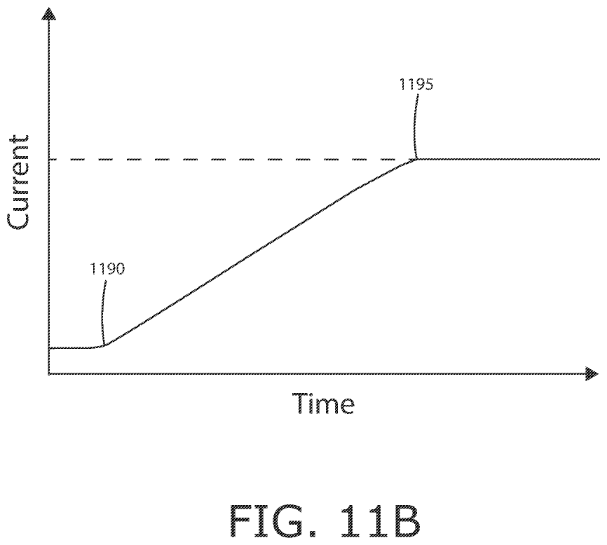

Referring to FIG. 11A, a schematic block diagram a winch and plow control system 1100 is depicted. In one or more embodiments the winch and plow control system includes the display 928. In various embodiments the display 928 includes one or more of a processor or a controller 1134. In certain embodiments the processor 1134 may be incorporated into the display 928, incorporated into a vehicle engine control module (ECM) 1148, or a separate processor with the vehicle 900. In various embodiments the display module 928 may reference, in various embodiments, a combination of the processor 1134, the display 1029, and other portions such as a memory including selected instructions for operation of the winch 920 and/or plow 914.

In various embodiments, as illustrated in FIG. 11A, the system 1100 may operate with an existing Polaris® HD winch having various features, such as an auto-stop feature that turns off the winch 920 as the cable 918 is retracted into the winch 920. The auto-stop feature may include a relay module 1166 and receives a signal from a switch at the fairlead, or other appropriate portion that indicates that the cable 918 is fully in. The relay 1166 may operate a solenoid 1158 at an auto-stop relay 1180 and close a switch 1160. Thus, the winch system 1100 may include an auto-stop or auto-off function with a switch or sensor at the fairlead.

In various embodiments, a winch motor 1162 of the winch 920 may be automatically and/or user controlled via the display module 928. The display 928 or processor 1134 provides a pair of low side drivers that are in association with a winch-in relay 1168 and winch-out relay 1170. In one or more embodiments the gear position sensor 1150 is configured to sense the current state of the transmission and output a signal to indicate the detected transmission state. For example, when the vehicle 900 is put into reverse, gear position sensor 1150 senses this location and provides this information either directly through an analog input or through a CAN bus 1146 to the display module 928, via the ECM 1148. It is understood by one skilled in the art that the CAN bus 1146 may be used in addition to and/or alternatively with other communication systems, such as an Ethernet or other wired or wireless communication systems or protocols. Thus, any appropriate communication system or protocol may be used in addition to and/or in place of the CAN bus 1146. The display module 928 having the processor 1134 provides ground to solenoid 1172 thereby closing switch 1174 of relay 1168 to deliver 12 volts from the operator presence switch 30, if present, to a winch contactor 64. These 12 volts are delivered via a battery 1176 through an ignition switch 1178. It is understood that the winch contactor 1164 need not be separate from the winch motor 1162 but may be incorporated therein and/or directly connected to the winch motor 1162. Further, as discussed herein, the winch motor 1162 may include a brushless DC motor and/or permanent magnet and may include incorporated controls separate and/or alternative to the winch contactor 1164.

With the switch 1174 closed and a switch 1160 closed, 12 volts is delivered to a winch-in input 1178 of winch contactor 1164 to deliver and provide positive (+) polarity of 12 volts on winch contact 1 and a negative (−) polarity on winch contact 2 to the winch motor 1162. In various embodiments, as understood by one skilled in the art, the winch contactor 1164 is an H-bridge that switches polarities to the winch motor 1162 to drive the winch motor 1162 in one of two directions. During the winch-in direction, the winch 920 is turned to draw the cable 918 into the winch 920 and during the winch-out the winch is turned to release or let out the cable 918.

When the gear position sensor switch 1150 senses a forward or low gear, this signal is also sent to the display module 928, via the CAN bus 1146 or directly via the analog input 1180, in order to provide ground to solenoid 1182 to close switch 1184 of the winch-out relay 1170. This provides 12 volts to the winch-out input 1186 of winch contactor 1164 thereby providing a positive (+) polarity to the winch 2 output and a negative (−) polarity to the winch 1 output to lower the plow 1114 by running the motor 1162 in the winch-out direction.

In various embodiments, the optional hard-wired operator presence switch 1130 is illustrated. If selected, the optional switch 1130 can be eliminated and the switch 1130 could be replaced with a hard wire acting as an always closed switch.

Thus, the winch system 1100 may be operated in various modes, such as a plow mode, winch mode, and the like, described further below. The winch system 1100, however, may also be used to operate or control the winch in other various configurations. For example, the winch may receive input from various sensors or vehicle sensors to determine whether to operate the winch or to stop operation of the winch. Thus, operation of the winch 920 may be based on selected inputs directly from the user or automatically, without user input, such as with input from sensors or operation of the vehicle 900.

In various embodiments, the winch control 1100 may include a current sense system or module 1120. The current sense module 1120 may be connected to a line or connection from the winch contactor 1164 to the winch motor 1162. As discussed above, the winch contactor 1164 is understood to be an H-bridge that operates the winch motor 1162 in either an in-direction or an out-direction (e.g., in two spinning directions) for operation or movement of the cable 918.

The current sensor 1120 may be any appropriate type of current sensor such as a low resistance current shunt, a bidirectional hall effect current sensor, or other current sensing device. The winch motor 162 is generally connected to a DC current supply, such as the battery 176, therefore a DC current sensing system may be provided. In various embodiments, the current sensor may include a current or shunt resistor such as a Power Metal Strip® Shunt Resistor (WSBS8518 sold by, Vishay Intertechnology, Inc. having a place of business at Shelton, Conn.). Additional current sensors may include a Tamura hall-effect sensor such as from the L01ZS05 series sold by Tamura Corporation, having a place of business at Tokyo, Japan. It is understood that the exemplary embodiment current sensors, as discussed above, are merely exemplary and any appropriate sensor may be used.

The current sensor 1120 may sense a current between the winch contactor 1164 and the winch motor 1162. The polarity of the current, when a DC motor is used as a winch motor 1162, may be used to determine a direction of the motor, such as an up or down position. Regardless of the type, the current sensor 1120 may send a signal to the control or display module 29. As discussed above, the display module 928 may include the processor 1134. The display module 29 may further include various components, such as a memory portion 1135. The memory portion 1135 may include logical instructions that may be accessed (e.g., recalled) and executed by the processor system 1134. It is further understood that any appropriate processor system may be provided with the vehicle 928, the control system on the winch motor 1162, or other appropriate location. Nevertheless, the processor 1134 may execute instructions based upon the signal and interpret the signal from the current sensor 1120.

Referring additionally to FIG. 11B, in one or more embodiments the ECM 1148 and/or current sensor 1120 is configured for load management in the winch control system 1100. In known engine systems and winch control systems, there can be a significant amount of time that a vehicle motor is spinning without generating power relative to the time the vehicle motor is spinning while generating power. For example, a 570 engine will have one power stroke for every two spins of engine rotation. In this scenario, any electrical load that is applied to the vehicle can result in engine stalls and/or torque spikes. For example, a step changes on current load being applied to the winch motor 1162 can be enough causes it to slow enough that it stalls. such as when a winch actuates and drops the voltage from 14.4V to 12V. More specifically, when the engine is operating below 2000 RPM, if the regulator output changes abruptly from a 25% load at approximately 14.4 V to 100% load at 12 V, the regulator output current would ordinarily “step up” from a 25% load to 100% load. At 1250 rpm over 750 ms this would occur over 6-7 power strokes.

As such, in various embodiments the ECM 1146 is programmed to address this problem by applying the current changes in a ramped fashion rather than a step up. To help eliminate abrupt torque spikes. For example, depicted in FIG. 11B, a ramped increase in current is shown from a 25% load 1190 to 100% 1195 load. In certain embodiments the Alternator and AC compressor would both need to be ramped in and torque load from both would need to be managed. Additionally, in certain embodiments the ECM would need to work in concert depending on the load size to help compensate for higher steady state torque on the motor 1162.

In one or more embodiments the control system 1110 includes additional and/or alternative control or sensor portions. In one or more embodiments, the system 1100 includes a controller 1200. In certain embodiments the controller 1200 can be a pulse width modulation (PWM) component. The controller 1200 may also be referred to as a motor controller to control various portions, such as the winch motor 1162. The controller 1200 may receive instructions and/or control logic from various components such as from the processor 1134 and/or an auxiliary control switch 1210. In addition, the control of the controller 1200 may be directly from the auxiliary mode switch 210, the processor 1134 of the display module 928, or communication through selected communication networks, such as the CAN bus 1146.

As discussed above, the display module 928 may include one or more switches, that may include hard switches and/or soft switches (e.g., changeable touch screen switches). The auxiliary mode switch 1210 may include or be provided in the vehicle 900, such as in a three-way toggle switch that may be used to control the winch motor 1162 and/or select a mode for the winch 920. Nevertheless, the auxiliary mode switch 1210 may provide an input to the controller 1200 through the processor 1134 and/or directly to the controller 1200. The controller 1200 may be used to provide selected input to the winch motor 1162 through the contractor 1164.

In one or more embodiments the controller 1200 may be any appropriate PWM including a KDS-Mini Brushed DC Controller (e.g., Part Number KDS24200E) sold by Kelly Controls, Inc. having a place of business at Valencia, Calif., USA and/or motor controllers (e.g., Model 1216 and/or model 1220) sold by Curtis Instruments, Inc. having a place of business at Mount Kisco, N.Y., USA. The controller 1200 as a PWM may operate to provide selected duty cycles to the winch motor 1162 through the winch contactor 1164. As discussed above, the winch contactor 1164 may be used to operate the winch motor in an in or out direction, as illustrated and described in the control system 1100. Accordingly, the winch motor 1162 may be operated at a selected duty cycle up to a maximum of 100% duty cycle based upon the pulses from the PWM 1200. The PWM 200 may be used to operate the winch motor at a selected duty cycle based upon selected or appropriate inputs, including mode selections for the winch 920. For example, the PWM 200 may operate at a selected duty cycle according to a selected logic.

In addition to providing different duty cycles, the controller 1200 may allow for operation of the winch motor 1162 in different manners. For example, the winch motor 1162 may be operated according to selected or different modes, as discussed above, to allow for different speeds of operation of the winch 920. The winch motor may be operated at a slow, medium, and high speed, during both in and out direction, rather than simply on and off. The different modes may be provided with different names, such as noted above including winch mode and plow mode or may be provided as alternate modes or selectable configurations by the user. Further, the user may operate the winch motor 1162 directly such as with controls on the display module 1129 to increase and decrease speed during use or operation of the winch motor at a selected time, rather than simply selecting a particular mode. Accordingly, during an out or in operation the user may operate the winch 920 at varying speeds based upon a direct input from the user during the in or out operation. The controller 1200 may be controlled to vary the duty cycle to the motor 1162 to achieve the various speeds selected by the user.

In various embodiments a brushless motor or a permanent magnet motor may include internal control systems that may also receive inputs from the user. The internal control systems may operate the winch motor 1162 according to selected duty cycles, including those discussed above.

Additionally, in various embodiments the control system 1100 may include a networking device 1218 various connections including Bluetooth® wireless connection protocols, WiFi® wireless connection protocols, and other appropriate wireless or wired connections to allow operation of the control system 1100 outside or separate from the vehicle 900. The operation of the winch 920 may be controlled to specifically control acceleration and deceleration of the winch motor 1162 and the associated spool including the cable 1118 during selected modes of operation.

In certain embodiments the controller 1200 can function as a variable output that may allow for the output from the battery 1176 to the winch motor 1162, such as through the winch contactor 1164, to be varied based upon a selected control logic from the processor 1134, or any appropriate control logic system or mechanism. For example, instructions may be used to operate the winch motor 1162 at a selected manner, such as allowing for force limiting on the cable 1118 and/or from the motor 1162, for various purposes. For example, a selected winch motor may be used to provide various maximum forces. The forces may be selected or varied (e.g., a selected maximum) with the variable output. In various embodiments, the control system 1100 may be programmed to allow for a maximum output through the variable output to select a power rating for the winch 920 and operation of the motor 1162. Selection of a power rating for the winch 920 to be less than a maximum possible power that a specific winch motor may be able to produce. The reduction of a maximum applied power may allow for the use of a single winch motor in different applications, such as cable types, uses, or the like. Thus, gearing or motors need not be changed to provide a different power rating or force rating for the different winches. For example, a cable, such as a steel cable of a selected size, strength, or the like.

Various sensors may be incorporated into the control system 1100 and/or the winch 920, including the winch control for the motor 1162. Additionally, and/or alternatively, various sensors may be incorporated into the winch 920, including within the winch motor 1162 and/or the winch spool for various purposes. For example, an encoder may be included, such as a rotary encoder, for determining speed and/or position of the winch motor and/or spool of the winch.

In various embodiments, an encoder 1350 may be incorporated into various portions of the winch 920. For example, the encoder 1350 may be incorporated into or at the winch motor 1162. The rotary encoder, exemplary discussed herein as the encoder 1350, may be incorporated into the winch assembly to provide a signal regarding various aspects of the motion of the winch motor 1162 to the control system 1100. The control system 1100 may include a connection between the processor 1134, such as included in the display module 928, and the rotary encoder 1350, directly or indirectly through the CAN bus 1146. Accordingly, a signal from the rotary encoder 1350 may be provided to the display module 928 to allow for operation of the winch 920 according to a selected control or control logic, as discussed further herein.

The rotary encoder 1350 may be provided to determine a speed of the winch motor 1162. The rotary encoder 1350 may, therefore, transmit a signal to be used to operate the winch motor 1162 at selected and various speeds according to the systems as discussed above. The winch encoder 1350 may be incorporated into a control system that includes the additional or other control features or sensors such as current sensor 1120 or the controller 1200. The winch motor 1162, therefore, may be controlled, at least in part, based upon a signal from the rotary encoder 1350. Thus, the control system 1100, either alone or in combination with the other systems or portions of the other control systems, may be used to assist in operating and controlling the winch 920.

The rotary encoder 1350 may transmit the encoder signal to the logic system or processor 1134 for various purposes. For example, the encoder 11350 may be used to count a number of turns of the winch spool to estimate an amount of rope that is let out or retrieved. The encoder 1350 and/or the processor 1134 may use the encoder signal to determine whether the cable 918 is near an end point, such as a “maximum out” or “maximum in”.

Further, the encoder 1350 may be used to determine a speed of the motor 1162 to assist in operation of the motor 1162 and to control the motor 1162 based upon various inputs. As discussed above, different cable materials for the cable 918 may be specified to have different speeds or power of the motor 1162 or proper operation of the cable 918. Thus, the encoder 11350 may be used for assisting and operating the motor 1162 of the winch assembly 920.

In one or more embodiments the control system 1100 can include one or more other sensors may be connected to the display module 928. For example, in various embodiments the display module 928 may receive additional sensor input from other vehicle sensors 1400 such as lighting controllers, engine controllers (e.g., ECM 1148), inertial measurement units (IMU), or other sensors on the vehicle 900. For example, an IMU may be included in the vehicle 900 to sense or measure an angle or position of the vehicle 900 in space and/or relative to the earth. As depicted in FIG. 11A, the vehicle sensors 1400 may communicate via the CAN bus 1146 with the display module 1129.

The vehicle sensors 1400 may include sensors and/or controllers for various systems. Exemplary, and not intended to be limiting, vehicle sensors 1400 may include: 1. Box (e.g., cargo area) lift Controller; 2. Lighting Controller; 3. Chassis/suspension Controller; 4. Brake Controller; 5. Steering Controller; 6. Engine Controller; 7. Transmission Controller 8. Displays and/or instrumentation; 9. Radio controllers; and 10. Auxiliary lighting

Additional discussion of the winch and plow control system, current sensors, and the like is found in U.S. Patent Publication 2021/0139299. This publication is incorporated by reference herein.

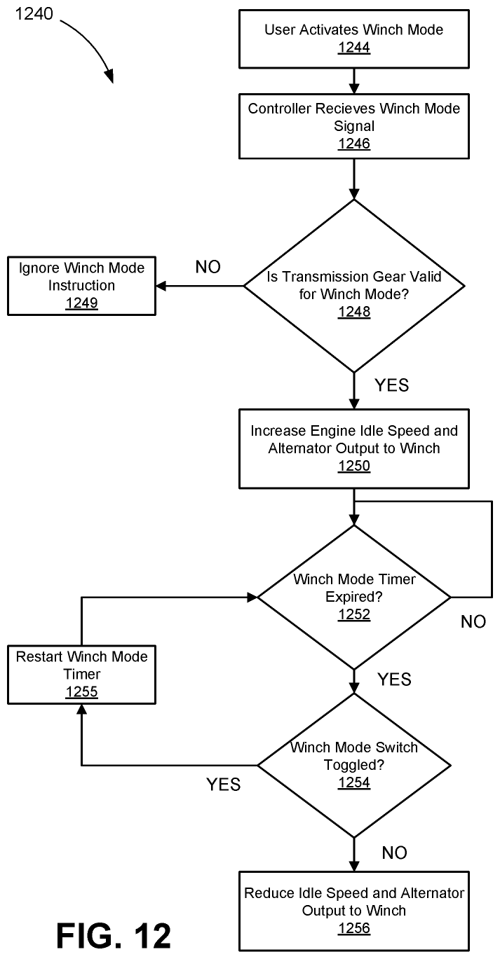

Referring to FIG. 12, a method 1240 of operation is depicted for the winch and plow control system 1100. In winching situations, it has been common for an operator to manually increase engine speed to provide more alternator output to reduce battery drain. This is performed by the user manually pressing on the accelerator pedal during winching operations to manually increase engine idle speed while in park or neutral gear. As such, method 1240 depicts a winch mode operation where the winch and plow control system automates an increase to engine speed to provide more alternator output and reduce potential drain on the battery 1176. For example, various embodiments of the method 1240 automate/control the engine idle speed for a customized amount of time to provide additional power.

In one or more embodiments the method 1240 includes, at operation 1244, a user activating a winch mode. In one or more embodiments, and as described above, various modes of operation for the winch control system 1100 can be activated by a user via the display module 928. For example, in certain embodiments, the display screen 1029 and/or the button interface 1036 allows a user to switch between various modes for controlling the winch 920 and plow 914. Once the winch mode is activated in various embodiments the display module 928 signals the controller 1200 and/or processor 1134, and/or ECM 1148. As such, in one or more embodiments the method 1240 includes, at operation 1246, the controller receiving the winch mode signal.

In one or more embodiments the method 1240 includes, at decision block 1248, determining whether the transmission gear is valid for winch mode. In various embodiments, the gear position sensor 1150 can perform a check to determine the current state of the vehicle transmission. If the vehicle is in a safe/approved gear for winch operations (e.g., park or neutral), then the controller 1200 will proceed to activate winch mode operations. In contrast, if the vehicle is not in a safe/approved gear for winch operations, then the controller 1200 may ignore the winch mode signal and/or indicate to the user that the vehicle is not in the correct gear for winch operations. For example, in certain embodiments the display module 928 could signal to the operator that the vehicle is in an unapproved transmission gear for winching. As such, if the transmission gear is not valid for winch mode operation, then the method 1240 progress to operation 1249, where the control system 1100 ignores the winch mode instructions from the user a user activating a winch mode and the method 1240 terminates. If the transmission gear is valid for winch mode operation, then the method 1240 progresses to operation 1250, where the control system 1100 increases engine idle speed to increase alternator output to winch motor 1162.

In one or more embodiments, at operation 1250, the ECM 1148 or other controller is instructed to increase engine idle speed by a predetermined amount to increase alternator output to battery 1176 and/or the winch motor 1162. For example, in certain embodiments the ECM 1148 will increase engine idle speed by 25% to 50%. However, in various embodiments the amount of engine idle speed increase can be set by the user to any value desired for improved operation of the winch and/or battery 1176.

In one or more embodiments the method 1240 includes, at decision block 1252, determining whether a winch mode timer has expired. For example, in various embodiments winch mode operation, with the increased engine idle speed will continue for a predetermined amount of time and, once that time has passed, the control system 1100 will resume normal engine operations. As such, in various embodiments If the winch mode timer has not expired then, then the method 1240 loops back to decision block 1252. If the winch mode timer has expired, then the method 1240 progresses to decision block 1254.

In various embodiments, at decision block 1254 the method 1240 includes determining whether a winch mode is toggled. In various embodiments, if increased engine speed is needed for extended durations for long winching situations, the operator can indicate that need via the display module 928 by repressing or holding a button/switch on the display interface. If the winch mode is toggled, then the method 1240 progresses to operation 1255 where the method 1240 includes restarting the winch mode timer and then progressing back to decision block 1252 to repeat the previous processes described.

If, the winch mode switch is not toggled at the expiration of the winch mode timer, then the method 1240 processes to operation 1256, where the control system 1100 decreases engine idle speed to normal parameters and resumes normal operation.

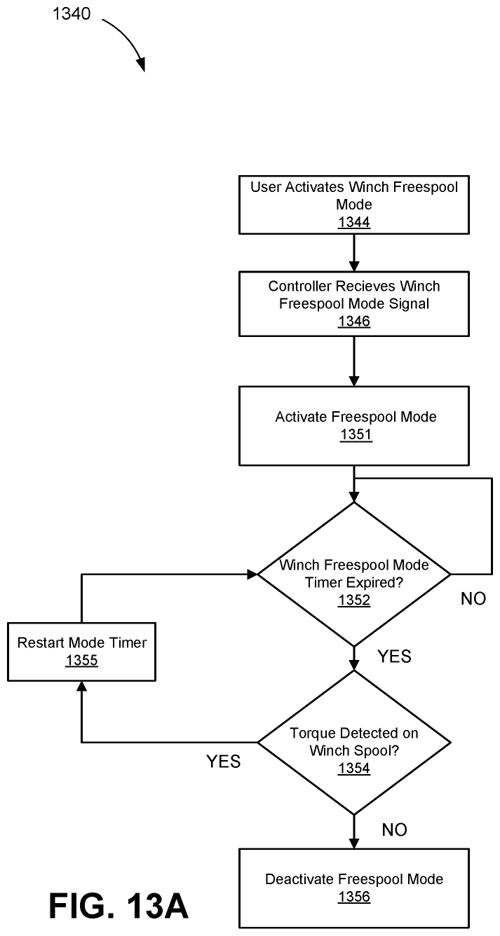

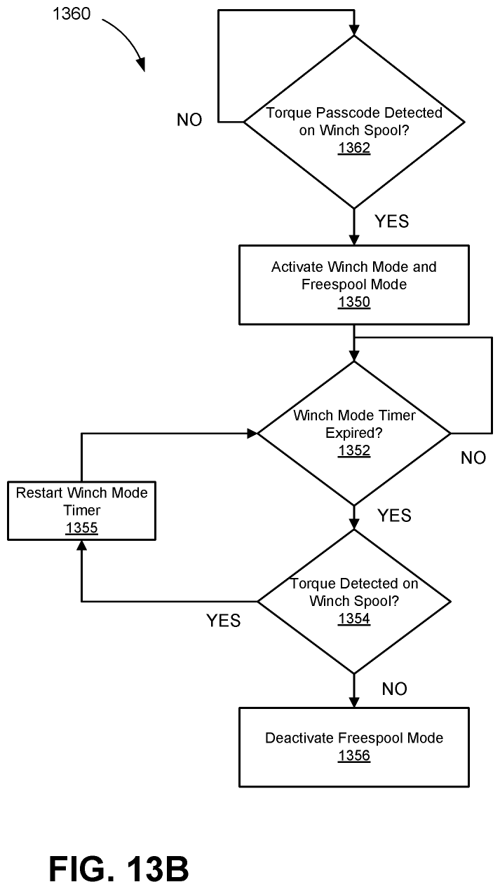

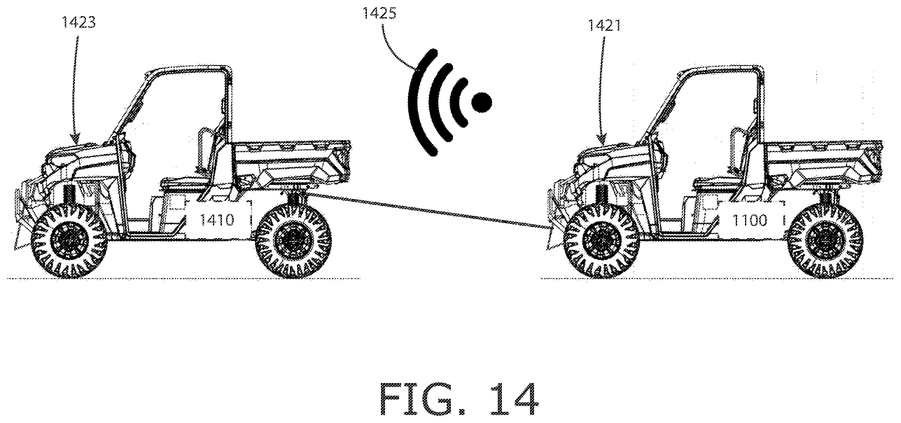

Referring to FIGS. 13A-B, methods 1340, 1360 of operation are depicted for the winch and plow control system 1100. As described above, in various embodiments, the winch motor 1162 can utilize the fine control over speed, current, and position. For example, using the controller 1200, encoder 1350, and current sensor 1120, the winch control system 1100 can determine the winch speed, position, current draw, and other information from the winch in real time. In various embodiments, the controller 1200 and/or display module 928 are configured to automatically activate a free spooling winch mode for the winch motor 1162 based on detected parameters. In such embodiments, once these parameters are detected the winch motor 1162 would assist the user in free spooling the winch cable 918 by feeding out the line while in a controlled fashion (e.g., with a small amount of resistance). In such embodiments the control system 1100 allows the user to activate free spooling quickly and easily without requiring the user to directly touch the gearbox or winch itself. For example, operators can activate free spooling remotely, for example by pulling on the cable 918 or by indicating that the free spooling mode is desired via a torque-based passcode in the form of a set of pulls on the rope 918, that when detected by the encoder 1350 automatically trigger the free spooling mode. In such embodiments the torque-based code functions to differentiate a human signal that freespooling is desired versus random or unintended torques on the cable. In such embodiments the passcode functions such that the winch assembly does not accidentally trigger freespooling without the operator intending it. Further, in various embodiments the operator can activate this mode without requiring the user to directly interface with the winch, the display 928, or even possess a remote.

Referring to FIG. 13A, in one or more embodiments the method 1340 includes, at operation 1244, a user activating a winch free spooling mode. As described above, the controller 1200, encoder 1350, and current sensor 1120, the winch control system 1100 can determine the winch speed, position, current draw, and other information from the winch in real time. In various embodiments, the controller 1200 and/or display module 928 are configured to automatically activate a free spooling winch mode for the winch motor 1162 based on detected parameters. In various embodiments, in operation 1244, the operator can apply a torque onto a winch cable 918 by pulling the cable outwardly from the winch. In such embodiments, once this torque is detected by the encoder 1350, the encoder can communicate with the controller 1200 and/or other winch control system to activate the free spooling mode. As such, in one or more embodiments the method 1340 includes, at operation 1346, the controller receiving the winch free spool mode signal. In one or more embodiments the method 1340 includes, at operation 1351, activating free spool mode. As described, once these parameters are detected the winch motor 1162 would assist the user in free spooling the winch cable 918 by feeding out the line while in a controlled fashion (e.g., with a small amount of resistance).

In one or more embodiments the method 1340 can optionally include determining whether the transmission gear is valid for freespooling. In various embodiments, the gear position sensor 1150 can perform a check to determine the current state of the vehicle transmission. If the vehicle is in a safe/approved gear for winch operations (e.g., park or neutral), then the controller 1200 will proceed to activate freespooling operations. In contrast, if the vehicle is not in a safe/approved gear for winch operations, then the controller 1200 may ignore the winch freespooling mode signal and/or indicate to the user that the vehicle is not in the correct gear for freespooling operations. For example, in certain embodiments the display module 928 could signal to the operator that the vehicle is in an unapproved transmission gear.

In one or more embodiments the method 1340 includes, at decision block 1352, determining whether a winch freespool mode timer has expired. For example, in various embodiments winch freespool mode operation will continue for a predetermined amount of time and, once that time has passed, the control system 1100 will resume normal operations. As such, in various embodiments If the timer has not expired then, then the method 1340 loops back to decision block 1352. If the mode timer has expired, then the method 1340 progresses to decision block 1354.

In various embodiments, at decision block 1354 the method 1340 includes determining whether torque is detected on the winch spool. In various embodiments, if freespooling is needed for extended durations, the operator can indicate that need by continuing to apply torque to the winch cable 918. If torque is detected, then the method 1340 progresses to operation 1355 where the method 1340 includes restarting the mode timer and then progressing back to decision block 1352 to repeat the previous processes described. If, the mode timer is not restarted, for example because no further torque is detected on the cable 918, then the method 1340 processes to operation 1356, where the control system 1100 deactivates freespooling mode and resumes normal winch operations.

Referring to FIG. 13B, a method 1360 is depicted showing a method of winch control system 1100 operation of a freespooling mode utilizing a “passcode” to initiate mode activation. In various embodiments, the method 1360 includes decision block 1362, where the method determines whether a torque-based passcode has been detected on the winch spool. As described above, operators can indicate to the control system 1100 that the free spooling mode is desired via a “passcode” or a set of pulls on the rope 918, that when detected by the encoder 1350 automatically trigger the free spooling mode. In such embodiments, the operator can activate this mode without requiring the user to directly interface with the winch, the display 928, or even possess a remote. For example, in certain embodiments the passcode could include three short pulls on the cable 918 within a set amount of time. In some embodiments the passcode would including two short pulls followed by one lone pull. However, the passcode could be programmed to include any amount of pulls, type of pulls, or combination of pulls. Regardless, the torque-based code should function to differentiate random torques on the cable versus a human operator intending to initiate freespooling. Once the operator performs those pulls on the cable the encoder 1350 can transmit a signal to controller 1200 or other component in the system 1100 to initiate freespool mode at operation 1351. In various embodiments, the method 1360 then follows the same path as method 1340, with operations 1350-1356 described above.

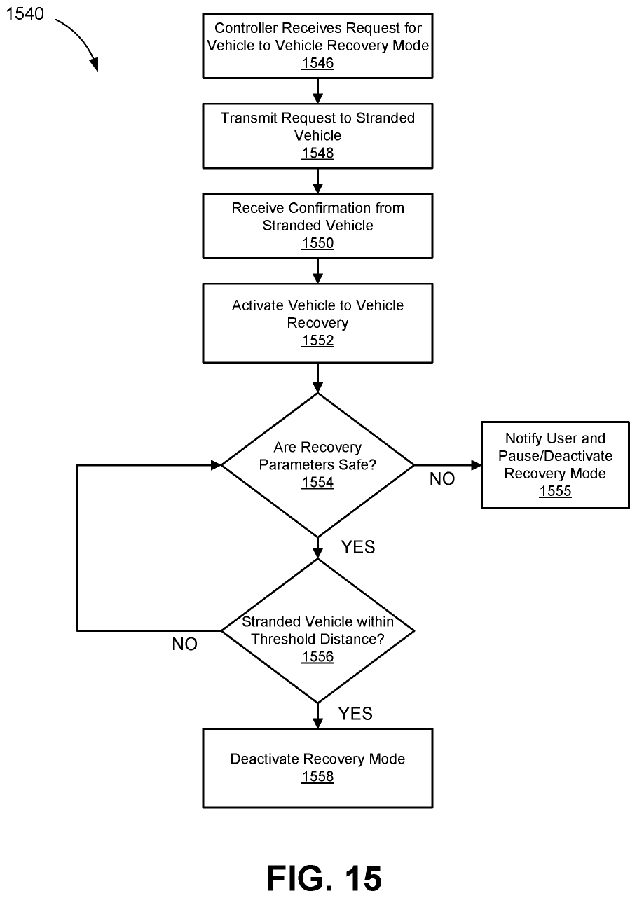

Referring to FIGS. 14-15, in one or more embodiments the winch and plow control system 1100 can be configured to operate in a vehicle-to vehicle recovery mode. In various embodiments the control system 1100 can be configured to utilize local wireless networking capabilities to communicate with nearby vehicles, such as a stranded vehicle 1423, to initiate a coordinated vehicle recovery. For example, in various embodiments a recovery vehicle 14211 and the stranded vehicle 1423 wirelessly connect, via signal 1425, their respective control systems 1100, 1410 and/or electronics to share data, send instructions, and the like. In various embodiments the control system 1100 would monitor data on both vehicles to ensure safety, improve the chances of recovery, and provide other added benefits.

As such, referring to FIG. 15, a method 1540 of operation in a vehicle-to-vehicle recovery mode is depicted for the winch and plow control system 1100. In one or more embodiments the method 1540 includes, at operation 1546, receiving a request at a controller to activate vehicle-to-vehicle recovery mode. In one or more embodiments, and as described above, various modes of operation for the winch control system 1100 can be activated by a user via the display module 928. For example, in certain embodiments, the display screen 1029 and/or the button interface 1036 allows a user to switch between various modes for controlling the winch 920 and plow 914. Once the recovery mode is activated in various embodiments the display module 928 signals the controller 1200 and/or processor 1134, and/or ECM 1148. As such, in one or more embodiments the method 1240 includes, at operation 1246, the controller receiving a signal to initiate a vehicle-to-vehicle recovery mode.

In one or more embodiments the method 1540 includes, at operation 1548, transmitting a request to initiate vehicle-to-vehicle recovery mode to a stranded vehicle. In various embodiments control system can utilize networking device 1218 to transmit a networking request in the nearby area to establish a vehicle-to-vehicle recovery mode. In such embodiments the control system 1100 will await a acceptance, for example via a return signal, that establishes a networked connection with a stranded vehicle. For example, in one or more embodiments the method 1540 includes, at operation 1550, receiving confirmation of vehicle-to-vehicle recovery mode from the stranded vehicle. In various embodiments the request to initiate vehicle-to-vehicle recovery will appear on a corresponding display module of the stranded vehicle 1423 that the operator of the vehicle can accept. Once accepted the corresponding control systems 1410, 1100 will initiate a networked connection and begin sharing data, instructions, and the like.

In one or more embodiments the method 1540 includes, at operation 1552, activating vehicle-to-vehicle recovery mode. In various embodiments, As the two vehicles are connected and the winch is put in use, the control systems perform an automatic engine assist. For example, in various embodiments the winch of the recovery vehicle 1421 would automatically send a torque request to the stranded vehicle 1423 to apply additional engine torque to its wheels to help with the rescue process. In such embodiments the application of engine torque on stranded vehicle can be subject to other parameters such as the winch/vehicle speed and vehicle orientation, or other parameters that define safe operating rules for the vehicle-to-vehicle mode.

For example, in one or more embodiments the method 1540 includes, at decision block 1554, determining whether vehicle-to-vehicle recovery parameters are within safe thresholds. In various embodiments, the safe operating thresholds include a plurality of parameters that define safe operating conditions for recovery mode and/or the application of engine torque in the stranded vehicle. In one or more embodiments these parameters include, as an example, a distance closure parameter, a vehicle orientation parameter, and engine transmission parameter.

In one or more embodiments the distance closure parameter includes of the relative speeds of the recovery winch and the speed of the stranded vehicle 1423. In such embodiments the connected system 1100 would verify, for example using encoder 1350, whether the stranded vehicle 1423 vehicle is moving at an appropriate rate in comparison to the winch speed of the recovery vehicle 1421. In such embodiments, if the system 1100 detects that the stranded vehicle 1423 is moving at a speed greater than the speed of the recovery which, the system 1100 would determine that an unsafe condition has been reached.

In various embodiments the vehicle orientation parameter, and engine transmission parameter describe vehicle state parameters that indicate whether the state of either the stranded vehicle or recovery vehicle are safe for operation of the recovery mode. In such embodiments vehicle sensors 1400, including engine controllers (e.g., ECM 1148), inertial measurement units (IMU), or other sensors will indicate whether the vehicle orientation, engine status, transmission status, or other status becomes unsafe. For example, in various embodiments the vehicle sensors 1400 can communicate to ensure vehicle state is appropriate for winching (e.g., transmission in park or neutral, vehicle not tipped over, brakes not depressed).

In various embodiments, the vehicle state parameters include the presence of the vehicle operator. For example, in one or more embodiments the operator presence switch 1130 will indicate whether a vehicle operator is currently positioned in the vehicle seat for operation of the winch and/or vehicle. In various embodiments the operator presence switch 1130 can include an associated seat belt switch. In such embodiments, the vehicle parameters could require a driver/passenger to have his/her seat belt fastened if sitting in the driver's/passengers seat(s) while the winch is being used. If the control system 1100 determines that the safe recovery parameters have been violated then, the method 1540 will progress to operation 1555. In such embodiments, at operation 1555 the system 1100 will notify the user of the unsafe conditions. In one or more embodiments the control system 1100 can pause vehicle-to-vehicle recovery. In such embodiments the pause can continue until safe conditions for recovery are reestablished. In certain embodiments the control system could deactivate vehicle-to-vehicle recovery once unsafe conditions are detected.

In one or more embodiments the method 1540 includes, at decision block 1556, determining whether the stranded vehicle is within a threshold recovery distance that indicates a minimum vehicle to vehicle distance. In various embodiments, the control system 1100 is configured to monitor the relative location of the vehicles and can automatically modify winching speed based on that distance and/or terminate the vehicle recovery process. In some embodiments, when the vehicle is further apart, the speed of engine torque assistance and/or winching would be higher and when the positions closes, the speeds would decrease to ensure safety. In certain embodiments the relative distances can be determined via the encoder, which can calculate the rope length on the winch and the remaining distance between the rope and the attached vehicle 1423. In some embodiments GPS or other location systems can be used to determine the relative distances between the vehicles.

If the control system 1100 determines that the stranded vehicle is within the threshold recovery distance, then the method the method 1540 will progress to operation 1558 where the control system 1100 deactivates recovery mode and resumes normal operating. In such embodiments, the system 1100 will end the networked connection between the two vehicles. In certain embodiments the control system of one or both vehicles can notify their respective operators that recovery was successful and/or of the termination of the vehicle network.

In one or more embodiments if the control system 1100 determines that the stranded vehicle is still outside of the threshold recovery distance then the method 1540 can loop back to decision block 1554 and continue vehicle recovery operations as described above in method operations/decisions 1552-1556.

While various embodiments describe a vehicle-to-vehicle recovery mode that involves multiple vehicles, in various embodiments the vehicle-to-vehicle recovery mode includes scenarios where a single stranded vehicle is winching itself, e.g., performing self-recovery, without the assistance of a recovery vehicle. In such embodiments the stranded vehicle can also utilize an IMU and/or other vehicle sensors to indicate whether the vehicle orientation, engine status, transmission status, or other status becomes unsafe for self-recovery. As above, if the control system 1100 determines that the safe recovery parameters have been violated, the system 1100 will notify the user of the unsafe conditions. In one or more embodiments the control system 1100 can pause vehicle-to-vehicle recovery. In such embodiments the pause can continue until safe conditions for recovery are reestablished. In certain embodiments the control system could deactivate vehicle-to-vehicle recovery once unsafe conditions are detected.

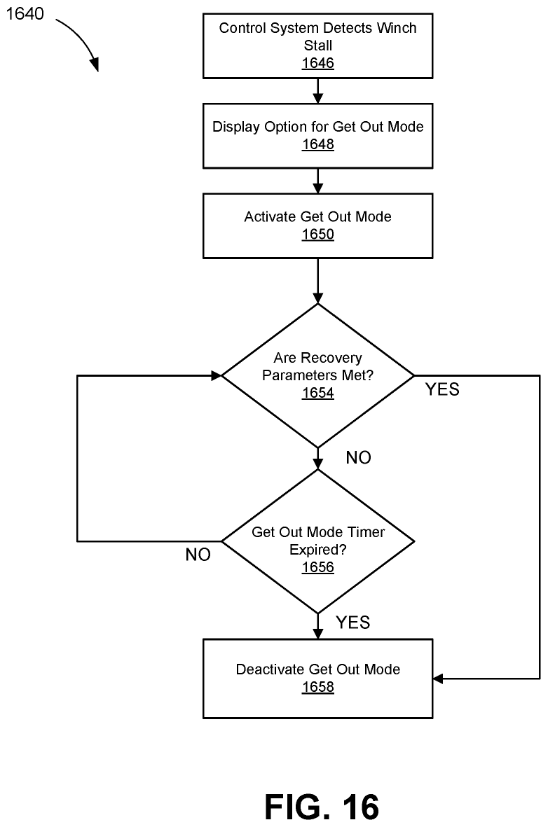

Referring to FIG. 16, a method 1640 of operation is depicted for the winch and plow control system 1100. In winching situations, such as in self-recovery situations, the winch generally operates as a normal winch and tries to pull up a vehicle up to its maximum limit where the winch then begins to stall out as the maximum limit of the winch is reached and/or exceeded. As such various embodiments are directed to a winch mode of operation, indicated as “Get Out Mode” where a winch that has stalled will begin to pull, stop, and then repeat periodically to attempt to rock the vehicle back and forward and assist with vehicle self-recovery.

In one or more embodiments the method 1640 includes, at operation 1646, detecting a winch stall. In various embodiments the winch motor 1162 and/or encoder 1350 can determine a stall condition where the maximum torque of the winch has been met. In response, the motor and/or encoder can signal the controller 1200 and/or display module 928 to submit a request to the operator to initiate Get Out Mode vehicle recovery. For example, in various embodiments, the method 1640 includes, at operation 1648, displaying a request for Get Out Mode recovery. In one or more embodiments, and as described above, various modes of operation for the winch control system 1100 can be activated by a user via the display module 928. For example, in certain embodiments, the display screen 1029 and/or the button interface 1036 allows a user to switch between various modes for controlling the winch 920 and plow 914. Once the winch mode is activated in various embodiments the display module 928 signals the controller 1200 and/or processor 1134, and/or ECM 1148.

In one or more embodiments the method 1640 includes, at operation 1650, activating Get Out mode. In such embodiments the control system 1100 begins to operate the winch by repeating a process of pulling, then pausing, and repeating the process periodically. In such embodiments this sequence of actions functions to rock the vehicle back and forward and assist with freeing the vehicle and initiate self-recovery. In one or more embodiments, this sequence can repeat until one or more recovery parameters are met and/or until a recovery timer has expired. In such instances, where the recovery timer has expired the system determines that self-recovery has failed and can indicate to the user that other methods of recovery may be needed.

For example, in one or more embodiments the method 1640 includes, at decision block 1654, determining whether vehicle recovery parameters have been met. In various embodiments, the recovery parameters include plurality of parameters that define whether the system detects that the vehicle has successfully become unstuck/recovered. In one or more embodiments these parameters include, as an example, wheel speed, throttle, torque in winch motor, or other vehicle parameters. If the control system 1100 determines that the stranded vehicle is recovered, such as via the recovery parameters then the method the method 1640 will progress to operation 1658 where the control system 1100 deactivates recovery mode and resumes normal operating.

In one or more embodiments the method 1640 includes, at decision block 1656, determining whether a Get Out mode timer has expired. For example, in various embodiments Get Out Mode will continue for a predetermined amount of time and, once that time has passed, the control system 1100 will resume normal engine operations. As such, in various embodiments If the winch mode timer has not expired then, then the method 1640 loops back to decision block 1654. If the winch mode timer has expired, then the method 1640 progresses to decision block 1658. In such instances, where the recovery timer has expired the system determines that self-recovery has failed and can indicate to the user that other methods of recovery may be needed.

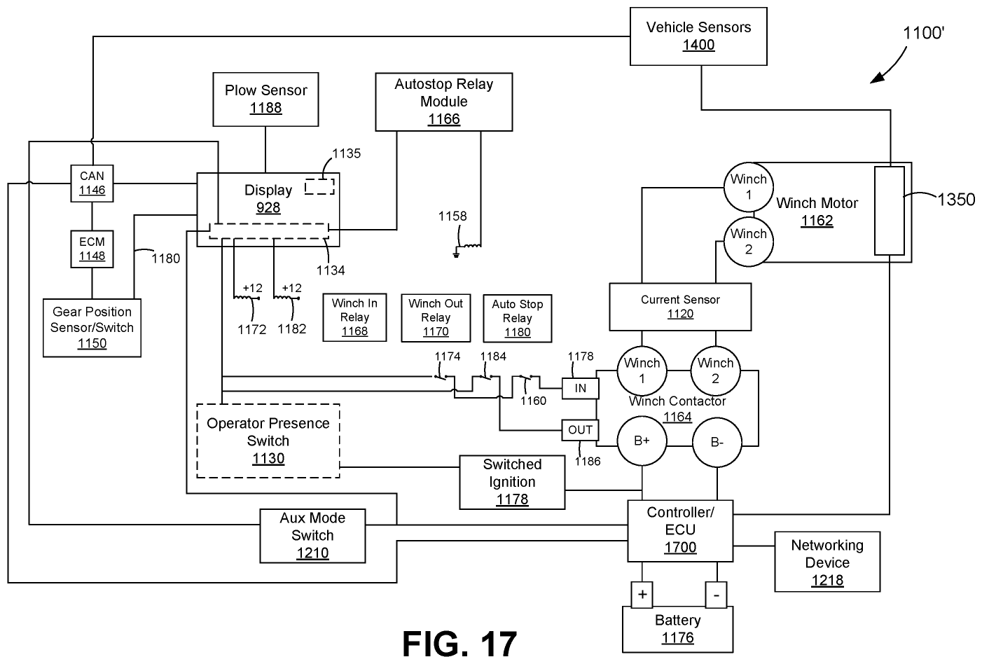

Referring to FIG. 17, a schematic block diagram a winch and plow control system 1100′ is depicted. In various embodiments winch control system 1100′ is substantially similar to control system 1100 described above with reference to FIG. 11A. However, in various embodiments though control system 1100′ additionally includes a controller and electronics control unit (ECU) 1700. In various embodiments the ECU is a logical device that is configured to control one or more of the electrical systems or subsystems in a car or other motor vehicle. In winch control systems known in the art, the control systems utilized a winch controller that was wired directly to the winch motor. In this configuration however, the winch control system and/or the engine had no visibility to the change in electrical load as the operator runs the winch. This tends to lead to undesirable effects for the operator. For example, this configuration can lead to engine stalls or engine speed flare ups under specific conditions, such as when the winch is operated in low power conditions.

As such, in various embodiments the control system 1100′ provides for the addition of an ECU 1700 positioned between the winch controls and the winch motor 112, such that the display module 928 is wired to the winch motor 1162 directly through the ECU 1700. In such embodiments the ECU provides the control system 1100′ and/or display module 928 visibility on when the customer is operating the winch. In such embodiments the this allows the ECU 1700 further includes logic/instructions to react to the additional electrical load on the engine to mitigate any engine issues such as stalling, low power, etc. For example, in various embodiments the winch request from the user will be sent via the vehicle CAN 1146 where ECU logic is added to allow the controller to disable drag torque adaptations during winch operation. In certain embodiments ECU logic is added to the winch request to allow controller to add reserve torque prior to allowing the winch to enable. In some embodiments, ECU logic added to allow the controller to disable winch operation during necessary conditions (e.g., low battery/charging system issues).

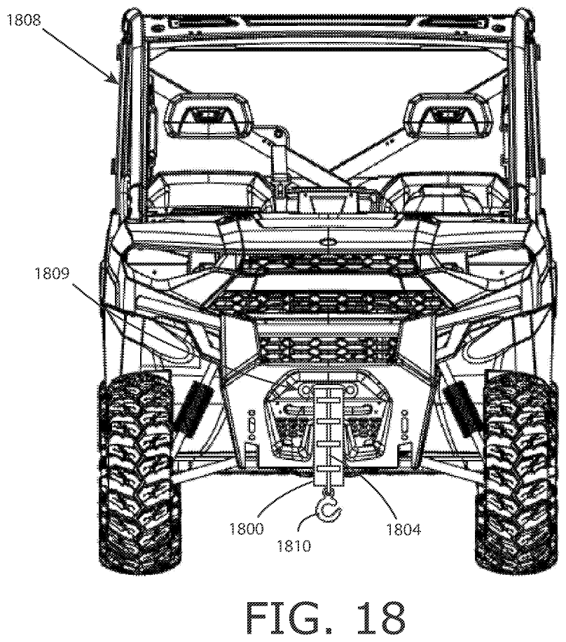

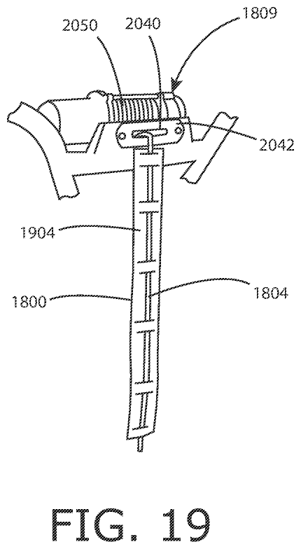

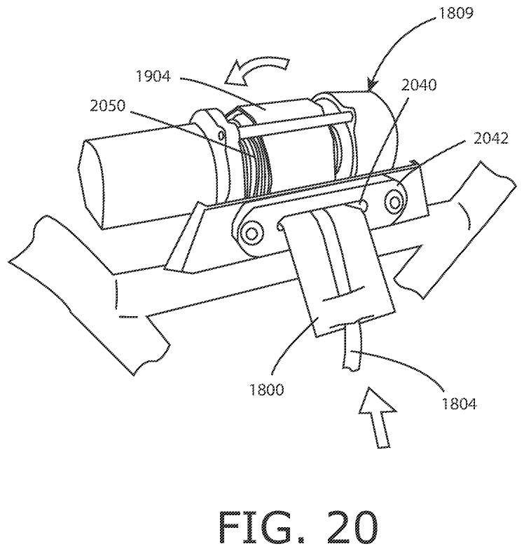

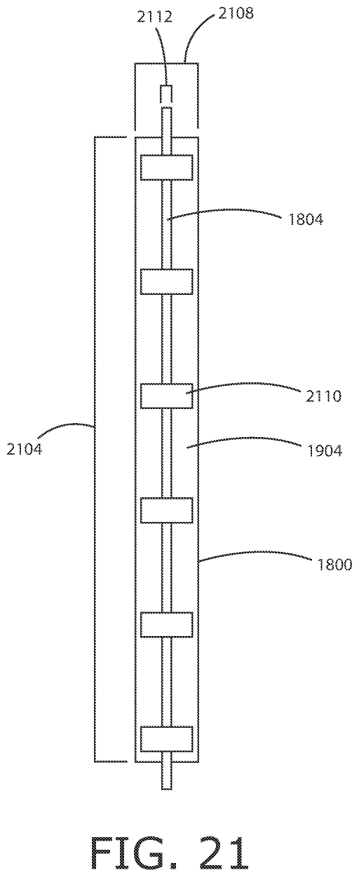

Referring to FIGS. 18-21, various views of a cable winch shim 1800 are depicted, according to one or more embodiments. In one or more embodiments the cable shim 1800 can be attached to the end of or near the end of a winch rope 1804 and used to reduce or eliminate the potential for the winch rope 1804 to bury itself into the rest of the spooled rope. For example, depicted in FIG. 18, a vehicle 1808 has a winch assembly 1809 with a winch rope 1804, and a cable shim 1800 The cable shim 1800 is positioned on the winch rope 1804 just rear of a hook 1810 and/or bump-stop. Referring additionally to FIGS. 19-21, in one or embodiments, the cable shim 1800 has a body 1904 with an elongated shape that extends lengthwise 2104 and widthwise 2108 In one or more embodiments the body 1904 includes a plurality of rope loops 2110 where the winch rope 1804 can be threaded through the loops 2110 to attach the shim 1800. The widthwise length of the shim 1800 is wider than the width 2112 of the cable 2112 but still sized such that the shim fits through the forward aperture 2040 of the fairlead 2042. As such, in various embodiments when the rope 1804 and the shim 1800 are retracted into the winch assembly 1809, the cable shim 1800 can be wound onto the winch spool 2050 with the end of the rope 1804. In such embodiments the shim 1800 creates a new winch drum surface to eliminate winch rope 1804 from burying in and binding in the spool 2050. In one or more embodiments the shim 1800 has a lengthwise 2104 length of approximately one to 5 feet. In certain embodiments, the shim has a widthwise 2108 width that is approximately equal to the size of the fairlead opening 2040. In certain embodiments the widthwise width 2108 is approximately four inches. In one or more embodiments the shim 1800 is constructed from a flexible material polyethylene, such as a high molecular weight polyethylene (HMWPE), as sheath for last few feet of winch rope would act as shim.

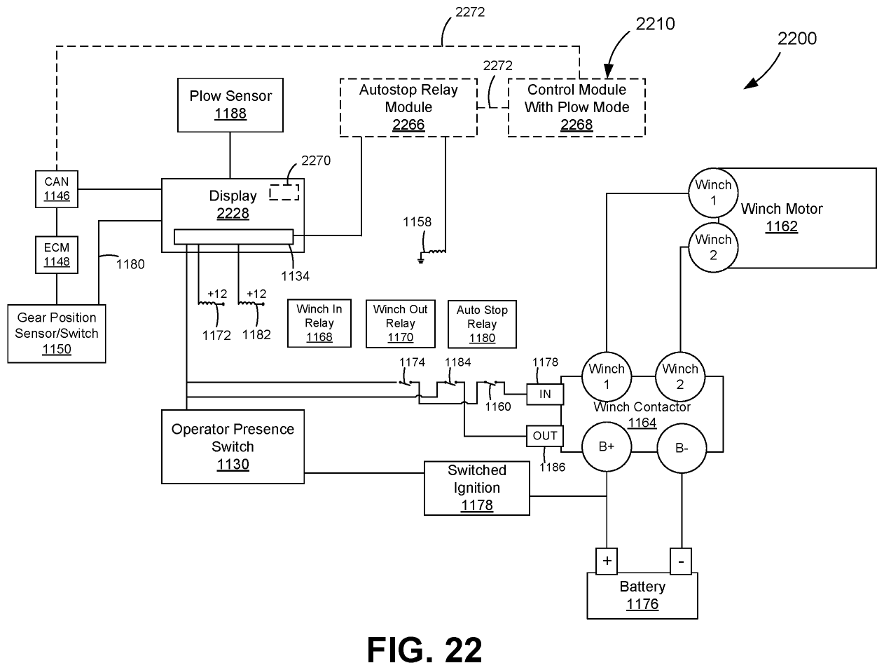

FIG. 22 depicts a schematic block diagram a winch and plow control system 2200 with an installed plow mode upgrade kit 2210, according to one or more embodiments of the disclosure. In various embodiments winch control system 2200 shares several components that are substantially similar to control system 1100 and 1100′ described above with reference to FIGS. 11 and 17. As such, shared components are referred to with the same reference number. However, the control system 2200 is depicted having an upgrade kit 2210 installed into the control system 2200 for that provides the system 2200 with capabilities for operating in a plow mode configuration.

Plow mode generally describes a mode the control system provides for left and right plow control outputs through a user interface display, and provides for a reverse gear triggered relay output to control backup lamps. In certain embodiments, plow mode includes logic for automatically lowering and/or raising an attached plow based on vehicle parameters detected, such as transmission gear placed into a low or forward gear. In a back drag plow mode, the plow is raised if the vehicle parameter detected is low or forward gear. If the gear detected is reverse, the plow is lowered automatically in the back drag mode. A detailed description of plow mode and the operation of a vehicle and/or plow in plow mode is found in U.S. Patent Pub. No. 2019/0382248 and is owned by the owner of the instant application and is incorporated by reference herein.

However, in various embodiments control system 2200 depicts a system that, without the installed upgrade kit 2210, would not ordinarily be capable of operating in plow mode. In such embodiments the upgrade kit 2210 provides a set of hardware and/or software that utilizes legacy systems, such as display 2228 which may not possess the processing, software, or other capabilities of the more capable hardware, such as display 928 described above, to provide plow mode functionality. In such embodiments, the upgrade kit provides hardware that off loads Plow Mode control workload from what would normally occur on the display 2228 and instead utilizes the hardware provided in the kit 2210. In certain cases, the provided hardware could provide additional functionality to the control system 2200. For example, in certain embodiments the control module 2268 could be configured to provide other functionality such as vehicle seat heating control. In such embodiments the control module 2268 simply includes a combination of hardware processing power that is combined with one or more sets of executable code which could provide a variety of functions, such as plow mode functionality.

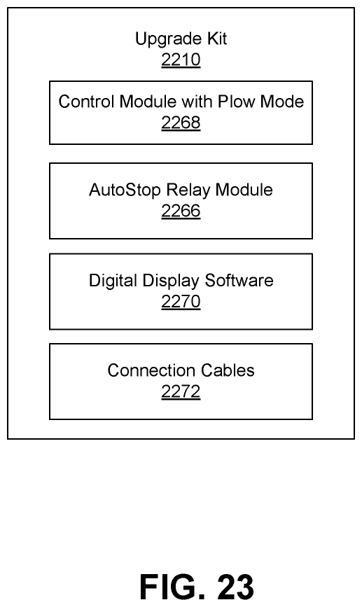

Referring additionally to FIG. 23 the upgrade kit 2210 is depicted, according to one or more embodiments. In various embodiments, the upgrade kit 100 is a collection of hardware and software for a winch and plow control system, that are selected for implementation with existing control systems, to facilitate configuration of existing hardware such that it in a Plow Mode as described above with reference to the embodiments and figures described herein. For instance, in various embodiments, while the existing winch and plow control system 2200 includes a display 2228, the system 2200 would typically lack the requisite

processing, Auto Stop functionality, wiring, and software upgrades to the display 2228 that are necessary to operate in plow mode. As such, in various embodiments the kit 2210 facilitates the upgrade of existing hardware such that without the additions provided in the kit 2210, the operation in plow mode would not be possible. In various embodiments the upgrade kit 1000 includes a control module 2268, an Autostop Relay module 2266, a digital display software package 2270, and connection cables 2272.

In various embodiments, the control module 2268 is a set of hardware and/or software that off loads the plow mode control workload from what would normally occur on the display 2228 and instead utilizes the hardware provided in the kit 2210. In certain cases, the provided hardware could provide additional functionality to the control system 2200. For example, in certain embodiments the control module 2268 could be configured to provide other functionality such as vehicle seat heating control. In such embodiments the control module 2268 simply includes a combination of hardware processing power that is combined with one or more sets of executable code which could provide a variety of functions, such as plow mode functionality.

In one or more embodiments the Autostop Relay module 2266 is a module configured to provide auto-stop or auto-off function with a switch or sensor at the fairlead. In such embodiments the module 2266 is substantially similar to relay module 1166. For example, in various embodiments the relay module 2266 is an attachable module configured to receives a signal from a switch at a fairlead, or other appropriate portion that indicates that the winch cable is fully in. The relay 2266 may operate a solenoid at an auto-stop relay and close a switch to stop the winch motor 1162. In various embodiments the connection cables 2270 include one or more suitable cables for connecting the control module 2268 and relay module 226 and the control module 2268 and the CAN 1146. In one or more embodiments the digital display software package 2270 includes a reflash card including various software, including program instructions as described above for implementing various processes, algorithms, or methods as described herein for operating in plow mode. In one or more embodiments

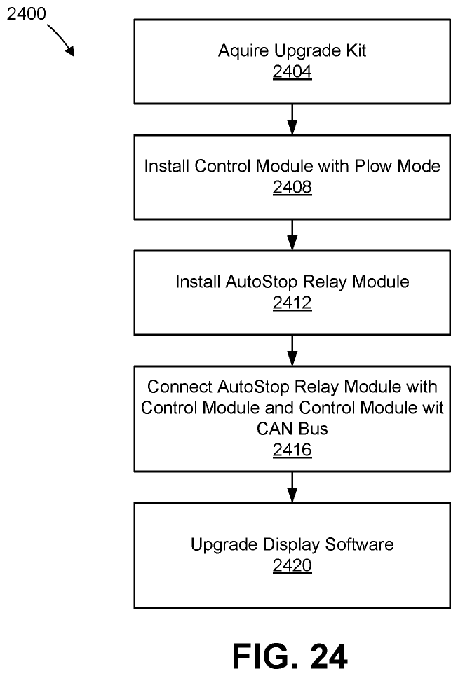

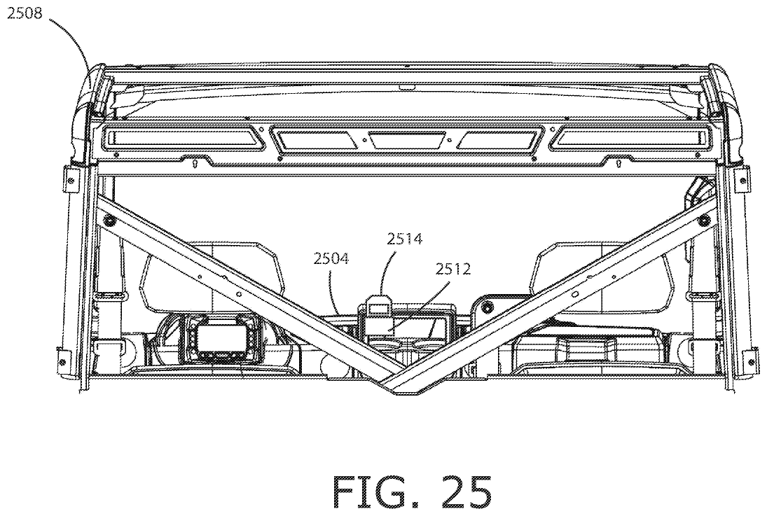

Referring to FIG. 24 a method 2400 of installing an upgrade kit is depicted. In various embodiments, the method 2400 includes, at operation 2404, acquiring an upgrade kit for plow mode functionality. As described above with reference, in various embodiments the upgrade kit includes a control module 2268, an Autostop Relay module 2266, a digital display software package 2270, and connection cables 2272. The method 2400 includes, at operation 2408, installing the control module. The method 2400 includes, at operation 2412, installing the Autostop Relay module. The method 2400 includes, at operation 2416, connecting the Autostop Relay module and control module and connecting the control module and the CAN bus. The method 2400 includes, at operation 2420, updating the display software using the digital display software package.

Referring to FIG. 25 a dashboard 2504 of a recreational vehicle 2508 having a winch control system is depicted, according to one or more embodiments of the disclosure. In one or more embodiments, the dashboard 2504 of the vehicle will include a multi-button display 2510, described above. In addition, in various embodiments the dashboard 2504 will include a dedicated remote holder 2512 that is configured to store a winch remote 2514. In such embodiments the remote holder 2512 can be an integral part of the dashboard 2504, for example as a molded piece of the dashboard 2504. In certain embodiments the remote holder 2512 will be a removable piece that can be moved and/or reattached to a part of the dashboard 2504 as desired by a user. Regardless, in various embodiments the remote holder 2512 is sized to receive and securely store the winch remote 2514 within.

In addition to the above disclosure, the following U.S. patents and patent publications are incorporated by reference herein: U.S. Pat. Nos. 7,201,366; 8,997,908; 9,102,205; 9,944,177; 10,883,235; 10,899,590; 11,085,528; 11,104,557; 2019/0194002; 2019/0382248; 2021/0139299; and 2021/0300472.

As used herein, the term “approximate”, “approximately” or the like is intended to mean that the value specified has a range of plus or minus 10% of the stated value.

The following clauses illustrate example subject matter described herein.

Clause 1: A modular winch system for mounting to a recreational vehicle, the modular winch system comprising: a spool; a spool frame including a first frame portion and a second frame portion configured to rotatably support the spool therebetween, and a top plate connecting the first and second frame portions and defining a top side of the spool frame, the first and second frame portions each including: a first face and second face, and a sidewall extending between the first and second faces; a plurality of vehicle mounting holes for fastening the modular winch system to a recreational vehicle, the vehicle mounting holes extended through the sidewall, approximately parallel with the first and second face; a secondary mounting hole extended partially through the sidewall approximately perpendicular to the vehicle mounting holes; and a spool connection interface including a bearing aperture for rotatably supporting an end of the spool, the bearing aperture extended through the first and second face approximately parallel with the sidewall; wherein the first frame portion includes a motor module connection interface configured to mount a winch motor selected from a plurality of different winch motors, the motor module connection interface including a plurality of winch module attachment holes extended through the first and second face approximately parallel with the sidewall, the plurality of attachment holes circumferentially spaced about the spool aperture and defining at least two pairs of attachment holes, each pair of attachment holes corresponding to a different rotational orientation about the spool aperture for an attached winch motor; wherein the second frame portion includes a gearbox module connection interface configured to mount a winch gearbox selected from a plurality of different winch gearboxes, the gearbox module connection interface including a plurality of winch module attachment holes extended through the first and second face approximately parallel with the sidewall, the plurality of attachment holes circumferentially spaced about the spool aperture and defining at least two pairs of attachment holes, each pair of attachment holes corresponding to a different rotational orientation about the spool aperture for an attached winch gearbox; and a plurality of winch modules including a winch motor, a winch gearbox, and a fairlead each connected to the spool frame; wherein the winch motor is attached to the motor module connection interface and has a rotational orientation defined by one of the pair of attachment holes and the gearbox is attached to the gearbox module connection interface and has a rotational orientation defined by one of the pair of attachment holes; wherein the spool frame is attachable to the recreational vehicle in at least two orientations including a horizontal orientation where the plurality of mounting holes are approximately horizontal relative to the earth, and a vertical mounting orientation where the plurality of mounting holes are approximately vertical relative to the earth; wherein in the horizontal orientation the fairlead is attached to the spool frame via the plurality of vehicle mounting holes of the first and second frame portions and the top plate is attached to the spool frame via the secondary mounting hole of the first and second frame portions, and wherein in the vertical orientation the top plate is attached to the spool frame via the plurality of vehicle mounting holes and the fairlead is attached to the spool frame via the secondary mounting hole of the first and second frame portions.

Clause 2: The modular winch system of clause 1, wherein the plurality of winch module attachment holes include at least eight attachment holes defining at least four pairs of attachment holes defining at least sixteen rotational orientations for an attached winch module.

Clause 3: The modular winch system of clause 2, wherein the at least four pairs of attachment holes are rotated approximately 45 degrees from one another about the spool aperture, such that the rotational orientation of an attached winch module can be incremented by 45 degrees.

Clause 4: The modular winch system of any one of clauses 1 through 3, wherein the motor module connection interface is configured to mount to a winch motor selected from a plurality of different winch motors each having one or more of a different size, a different connection interface, and a different type of motor.

Clause 5: The modular winch system of any one of clauses 1 through 4, wherein the gearbox module connection interface is configured to mount to a winch gearbox selected from a plurality of different winch gearboxes each having one or more of a different size, a different connection interface, and a different type of gearbox.

Clause 6: The modular winch system of any one of clauses 1 through 5, wherein the gearbox module connection interface and the motor module connection interface are the same.

Clause 7: The modular winch system of any one of clauses 1 through 6, wherein the gearbox module connection interface and the motor modular connection interface are different.

Clause 8: The modular winch system of any one of clauses 1 through 7, further comprising the recreational vehicle, wherein the spool frame is attached to the vehicle in one of the horizontal orientation and the vertical orientation.

Clause 9: The modular winch system of any one of clauses 1 through 8, wherein the motor is one of a standard DC motor and a brushless DC motor.

Clause 10: The modular winch system of any one of clauses 1 through 9, wherein the gearbox includes one of a manual freespool and a remote freespool.

Clause 11: The modular winch system of any one of clauses 1 through 10, wherein the gearbox includes a freespool handle projecting outwardly, wherein the rotational orientation of the gearbox defines the rotational orientation of the freespool handle.

Clause 12: The modular winch system of any one of clauses 1 through 11, wherein the motor includes a power terminal projecting outwardly, wherein the rotational orientation of the motor defines the rotational orientation of the power terminal.

Clause 13: A winch stop system comprising: a bump stop body having a sidewall extending between an annular forward face and an annular rearward face, the sidewall defining an exterior surface and an interior space between the annular forward and rearward faces, the annular forward face and the annular rearward face defining a pathway through the bump stop body for passage of a winch rope along a rope axis; a lighting array positioned in the annular forward face, the lighting array including one or more lighting elements and a battery configured to power the one or more lighting elements, the one or more lighting elements configured to emit light for illuminating objects forward of the bump stop body; one or more charging contacts positioned in the annular rearward face; and a metal spring positioned in the interior space, the metal spring electrically connecting the battery and the one or more charging contacts, wherein the metal spring is configured to compress with the bump stop body along the rope axis.

Clause 14: The winch stopper system of clause 13, further comprising: a fairlead having a forward-facing surface including one or more charging contacts; a power supply electrically connected to the one or more charging contacts of the fairlead; wherein the one or more charging contacts of the fairlead are configured to connect to the one or more charging contacts in the annular rearward face of the bump stop body, and wherein the fairlead and the metal spring are configured to electrically connect the battery to the power supply for charging the battery.

Clause 15: The winch stopper system of clause 13 or 14, wherein the metal spring is overmolded into at least a portion of the forward and rearward faces of the bump stop body.

Clause 16: The winch stopper system of any one of clauses 13 through 15, further comprising: a first magnet positioned in the rearward face of the bump stop body; and a second magnet positioned in the forward-facing surface of the fairlead; wherein the first magnet and second magnet are positioned such that when the first and second magnets connect the one or more charging contacts of the fairlead are aligned with the one or more charging contacts of the bump stop body.

Clause 17: The winch stopper system of any one of clauses 13 through 16, further comprising: a magnet positioned in the rearward face of the bump stop body; a magnetic switch positioned in the forward face of the fairlead, wherein the magnetic switch is configured to be triggered by the magnet when the rearward face of the bump stop body contacts the forward surface of the fairlead; and a controller coupled with the magnetic switch, wherein the controller is configured to output a signal for instructing a winch motor to stop operation in response to the magnetic switch being triggered.

Clause 18: The winch stopper system of any one of clauses 13 through 17, wherein the one or more lighting elements are LEDs.

Clause 19: The winch stopper system of any one of clauses 13 through 18, wherein the one or more lighting elements are circumferentially spaced about the annular forward face.

Clause 20: The winch stopper system of any one of clauses 13 through 19, wherein the bump stop body includes two or more pieces that are fastened together.

Clause 21: The winch stopper system of any one of clauses 13 through 20, wherein the bump stop body is formed from one or more of rubber and plastic.

Clause 22: A method of controlling a winch assembly for a first vehicle having a winch motor, using a winch control system including a controller having a processor operable to execute instructions; a memory module operable to store the instructions for execution by the processor; a winch assembly having a winch motor in communication with the controller; and at least one auxiliary module including at least one of: a sensor operable to transmit a sensor signal to at least one of the controller or the winch motor, a winch motor controller, or a communication system, wherein the winch motor is operable according to the controller executing the instructions, the method comprising: receiving at the winch control system an operator request to execute a set of instructions stored in the memory module; determining a vehicle transmission gear using the sensor; executing the requested set of instructions in response to determining that a transmission gear is valid for executing the instructions; determining that a mode timer for execution of the set of instructions has expired; ending execution of the set of instructions and resuming normal operations in response.

Clause 23: The method of clause 22, wherein the set of instructions causes the controller to increase engine idle speed to a predetermined amount to increase alternator output to battery and/or the winch motor.

Clause 24: The method of clause 23, wherein the engine idle speed increase increases idle speed by 25% to 50%.

Clause 25: The method of any one of clauses 22 through 24, wherein the operator request to execute a set of instructions is a torque detected on the winch motor and wherein the set of instructions causes the controller to freespool winch cable out of the winch assembly via the winch motor.

Clause 26: The method of any one of clauses 22 through 25, wherein the operator request to execute a set of instructions is a torque-based passcode detected by the winch motor and wherein the set of instructions causes the controller to freespool winch cable out of the winch assembly via the winch motor.

Clause 27: The method of any one of clauses 22 through 26, wherein the method further comprises establishing a network with a second vehicle using the communication system; wherein the set of instructions causes the controller retract the winch and to instruct the second vehicle to apply engine torque to its wheels.

Clause 28: The method of clause 27, wherein the method further comprises: determining that one or more vehicle-to-vehicle rescue parameters are within a threshold, wherein the one or more vehicle-to-vehicle parameters include vehicle orientation, vehicle speed, and a relative distance between the first and second vehicles.

Clause 29: The method of clause 28, wherein the vehicle-to-vehicle parameters include operator presence.

Clause 30: The method of any one of clauses 22 through 29, wherein the method further comprises: determining that one or more self-recovery rescue parameters are within a threshold, wherein the one or more rescue parameters include vehicle orientation, and vehicle speed of the first vehicle.

Clause 31: The method of c any one of clauses 22 through 30, wherein the set of instructions causes the controller to operate the winch motor by repeating a process of pulling and pausing.

Clause 32: The method of any one of clauses 22 through 31, wherein the winch control system further includes a user interface, wherein the controller includes a controller and electronics control unit (ECU) positioned between the user interface and the winch motor, such that the user interface is wired to the winch motor directly through the ECU.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A modular winch system for mounting to a recreational vehicle, the modular winch system comprising:
a spool;
a spool frame including a first frame portion and a second frame portion configured to rotatably support the spool therebetween, and a top plate connecting the first and second frame portions and defining a top side of the spool frame, the first and second frame portions each including:
a first face and second face, and a sidewall extending between the first and second faces;
a plurality of vehicle mounting holes for fastening the modular winch system to a recreational vehicle, the vehicle mounting holes extended through the sidewall, approximately parallel with the first and second face;
a secondary mounting hole extended partially through the sidewall approximately perpendicular to the vehicle mounting holes; and
a spool connection interface including a bearing aperture for rotatably supporting an end of the spool, the bearing aperture extended through the first and second face approximately parallel with the sidewall;
wherein the first frame portion includes a motor module connection interface configured to mount a winch motor selected from a plurality of different winch motors, the motor module connection interface including a plurality of winch module attachment holes extended through the first and second face approximately parallel with the sidewall, the plurality of attachment holes circumferentially spaced about the spool aperture and defining at least two pairs of attachment holes, each pair of attachment holes corresponding to a different rotational orientation about the spool aperture for an attached winch motor;
wherein the second frame portion includes a gearbox module connection interface configured to mount a winch gearbox selected from a plurality of different winch gearboxes, the gearbox module connection interface including a plurality of winch module attachment holes extended through the first and second face approximately parallel with the sidewall, the plurality of attachment holes circumferentially spaced about the spool aperture and defining at least two pairs of attachment holes, each pair of attachment holes corresponding to a different rotational orientation about the spool aperture for an attached winch gearbox; and
a plurality of winch modules including a winch motor, a winch gearbox, and a fairlead each connected to the spool frame;
wherein the winch motor is attached to the motor module connection interface and has a rotational orientation defined by one of the pair of attachment holes and the gearbox is attached to the gearbox module connection interface and has a rotational orientation defined by one of the pair of attachment holes;
wherein the spool frame is attachable to the recreational vehicle in at least two orientations including a horizontal orientation where the plurality of mounting holes are approximately horizontal relative to the earth, and a vertical mounting orientation where the plurality of mounting holes are approximately vertical relative to the earth;
wherein in the horizontal orientation the fairlead is attached to the spool frame via the plurality of vehicle mounting holes of the first and second frame portions and the top plate is attached to the spool frame via the secondary mounting hole of the first and second frame portions, and wherein in the vertical orientation the top plate is attached to the spool frame via the plurality of vehicle mounting holes and the fairlead is attached to the spool frame via the secondary mounting hole of the first and second frame portions.

2. The modular winch system of claim 1, wherein the plurality of winch module attachment holes include at least eight attachment holes defining at least four pairs of attachment holes defining at least sixteen rotational orientations for an attached winch module.

3. The modular winch system of claim 2, wherein the at least four pairs of attachment holes are rotated approximately 45 degrees from one another about the spool aperture, such that the rotational orientation of an attached winch module can be incremented by 45 degrees.

4. The modular winch system of claim 1, wherein the motor module connection interface is configured to mount to a winch motor selected from a plurality of different winch motors each having one or more of a different size, a different connection interface, and a different type of motor.

5. The modular winch system of claim 1, wherein the gearbox module connection interface is configured to mount to a winch gearbox selected from a plurality of different winch gearboxes each having one or more of a different size, a different connection interface, and a different type of gearbox.

6. The modular winch system of claim 1, wherein the gearbox module connection interface and the motor module connection interface are the same.

7. The modular winch system of claim 1, wherein the gearbox module connection interface and the motor modular connection interface are different.

8. The modular winch system of claim 1, further comprising the recreational vehicle, wherein the spool frame is attached to the vehicle in one of the horizontal orientation and the vertical orientation.

9. The modular winch system of claim 1, wherein the motor is one of a standard DC motor and a brushless DC motor.

10. The modular winch system of claim 1, wherein the gearbox includes one of a manual freespool and a remote freespool.

11. The modular winch system of claim 1, wherein the gearbox includes a freespool handle projecting outwardly, wherein the rotational orientation of the gearbox defines the rotational orientation of the freespool handle.

12. The modular winch system of claim 1, wherein the motor includes a power terminal projecting outwardly, wherein the rotational orientation of the motor defines the rotational orientation of the power terminal.

13. A modular winch system comprising:
a spool;
a spool frame including a first frame portion and a second frame portion configured to rotatably support the spool therebetween, the first and second frame portions each including:
a first face and second face, and a sidewall extending between the first and second faces;
a plurality of vehicle mounting holes for fastening the modular winch system to a recreational vehicle, the vehicle mounting holes extended through the sidewall;
a secondary mounting hole extended partially through the sidewall approximately perpendicular to the vehicle mounting holes; and
a spool connection interface including a bearing aperture for rotatably supporting an end of the spool, the bearing aperture extended through the first and second face approximately parallel with the sidewall; and
a plurality of winch modules including a winch motor, a winch gearbox, and a fairlead each connected to the spool frame, wherein the first frame portion includes a motor module connection interface configured to mount the winch motor and has a rotational orientation defined by one of the pair of attachment holes, wherein the second frame portion includes a gearbox module connection interface configured to mount the winch gearbox and has a rotational orientation defined by one of the pair of attachment holes.

14. The modular winch of claim 13, wherein the motor module connection interface including a plurality of winch module attachment holes extended through the first and second face approximately parallel with the sidewall, the plurality of attachment holes circumferentially spaced about the spool aperture and defining at least two pairs of attachment holes, each pair of attachment holes corresponding to a different rotational orientation about the spool aperture for an attached winch motor.

15. The modular winch of claim 13, wherein the gearbox module connection interface including a plurality of winch module attachment holes extended through the first and second face approximately parallel with the sidewall, the plurality of attachment holes circumferentially spaced about the spool aperture and defining at least two pairs of attachment holes, each pair of attachment holes corresponding to a different rotational orientation about the spool aperture for an attached winch gearbox.

16. The modular winch of claim 13, wherein the spool frame is attachable to the recreational vehicle in at least two orientations including a horizontal orientation where the plurality of mounting holes are approximately horizontal relative to the earth, and a vertical mounting orientation where the plurality of mounting holes are approximately vertical relative to the earth.

17. The modular winch of claim 16, wherein in the horizontal orientation the fairlead is attached to the spool frame via the plurality of vehicle mounting holes of the first and second frame portions and the top plate is attached to the spool frame via the secondary mounting hole of the first and second frame portions, and wherein in the vertical orientation the top plate is attached to the spool frame via the plurality of vehicle mounting holes and the fairlead is attached to the spool frame via the secondary mounting hole of the first and second frame portions.

18. The modular winch of claim 13, wherein the spool extends along a spool plane substantially perpendicular to each of the first frame portion and the second frame portion, wherein the plurality of vehicle mounting holes are approximately parallel with the first and second face, wherein at least a first vehicle mounting hole of each of the first frame portion and the second frame portion is substantially normal to the spool plane, and wherein at least a second vehicle mounting hole of each for the first frame portion and the second frame portion intersects the spool plane at an non-perpendicular angle.
